(19) United States
(12) Patent Application Publication
(10) Pub. No.: US 2017/0051207 A1
(43) Pub. Date: Feb. 23, 2017

(54) LIQUID CRYSTAL COMPOSITION AND LIQUID CRYSTAL DISPLAY DEVICE

(71) Applicants: JNC CORPORATION, TOKYO (JP); JNC PETROCHEMICAL CORPORATION, TOKYO (JP)

(72) Inventor: EIJI OKABE, CHIBA (JP)

(73) Assignees: JNC CORPORATION, TOKYO (JP); JNC PETROCHEMICAL CORPORATION, TOKYO (JP)

(21) Appl. No.: 15/306,105

(22) PCT Filed: Jan. 21, 2015
(86) PCT No.: PCT/JP2015/051441

§ 371 Date: Oct. 23, 2016

(30) Foreign Application Priority Data
Apr. 25, 2014 (JP) 2014-091509

(51) Int. Cl. C09K 19/34; C09K 19/20; C09K 19/02; C09K 19/30

(52) U.S. Cl. CPC C09K 19/3402; C09K 19/3001; C09K 19/3003; C09K 19/3059; C09K 19/20; C09K 19/0208; C09K 2019/3016; C09K 2019/3063; C09K 2019/3422; C09K 2019/3009; G02F 1/134363

(57) ABSTRACT

A liquid crystal composition satisfying at least one of characteristics such as high maximum temperature of a nematic phase, low minimum temperature thereof, large optical anisotropy, large positive dielectric anisotropy and high stability to ultraviolet light, or having suitable balance regarding at least two of the characteristics; and a liquid crystal display device including such a composition and particularly including an encapsulated composition, and a liquid crystal display device serving as a constituent of a display device that allows switching of display between 2D and 3D. The liquid crystal composition contains a specific compound having large optical anisotropy as a first component and a specific compound having large positive dielectric anisotropy as a second component, and may further contain a specific compound having large optical anisotropy and further having high maximum temperature or low minimum temperature as a third component, and the liquid crystal display device includes the composition.

### TECHNICAL FIELD

The invention relates to a liquid crystal composition, a liquid crystal display device including the composition, and so forth. In particular, the invention relates to a liquid crystal composition having a large optical anisotropy and a large positive dielectric anisotropy, and a device including the composition.

### BACKGROUND ART

In a liquid crystal display device, a classification based on an operating mode for liquid crystal molecules includes a phase change (PC) mode, a twisted nematic (TN) mode, a super twisted nematic (STN) mode, an electrically controlled birefringence (ECB) mode, an optically compensated bend (OCB) mode, an in-plane switching (IPS) mode, a vertical alignment (VA) mode, a fringe field switching (FFS) mode, and a field-induced photo-reactive alignment (FPA) mode. A classification based on a driving mode in the device includes a passive matrix (PM) and an active matrix (AM). The PM is classified into static, multiplex and so forth, and the AM is classified into a thin film transistor (TFT), a metal insulator metal (MIM) and so forth. The TFT is further classified into amorphous silicon and polycrystal silicon. The latter is classified into a high temperature type and a low temperature type according to a production process. A classification based on a light source includes a reflective type utilizing natural light, a transmissive type utilizing backlight and a transflective type utilizing both the natural light and the backlight.

The liquid crystal display device includes a liquid crystal composition having a nematic phase. The composition has suitable characteristics. An AM device having good characteristics can be obtained by improving the characteristics of the composition. Table 1 below summarizes a relationship in two characteristics. The characteristics of the composition will be further described based on a commercially available AM device. A temperature range of the nematic phase relates to a temperature range in which the device can be used. A preferred maximum temperature of the nematic phase is about 70° C. or higher, and a preferred minimum temperature of the nematic phase is about −10° C. or lower. Viscosity of the composition relates to a response time in the device. A short response time is preferred for displaying moving images on the device. A shorter response time even by one millisecond is desirable. Accordingly, a small viscosity in the composition is preferred. However, the small viscosity does not apply to a mode (for example, a polymer-stabilized blue phase (PSBP) liquid crystal display, a nanocapsule liquid crystal display) to show electric field induced transition based on a Kerr effect, and a higher-speed response can be expected regardless of a viscosity of a liquid crystal.

TABLE 1
Characteristics of Composition and AM Device

| No. | Characteristics of composition | Characteristics of AM device |
|---|---|---|
| 1 | Wide temperature range of a | Wide usable temperature range |
| | nematic phase | |
| 2 | Small viscosity ¹⁾ | Short response time |
| 3 | Suitable optical anisotropy | Large contrast ratio |
| 4 | Large positive or negative | Low threshold voltage and |
| | dielectric anisotropy | small electric power consumption |
| | | Large contrast ratio |
| 5 | Large specific resistance | Large voltage holding ratio and |
| | | large contrast ratio |
| 6 | High stability to ultraviolet | Long service life |
| | light and heat | |
| 7 | Large elastic constant | Large contrast ratio and |
| | | short response time |

¹⁾ A composition can be injected into a liquid crystal display device in a short time.

An optical anisotropy of the composition relates to a contrast ratio in the device. According to a mode of the device, a large optical anisotropy or a small optical anisotropy, more specifically, a suitable optical anisotropy is required. A product (Δn× d) of the optical anisotropy (Δn) of the composition and a cell gap (d) in the device is designed so as to maximize the contrast ratio. A suitable value of the product depends on a type of the operating mode. In a device having a mode such as TN, a suitable value is about 0.45 micrometer. In the above case, a composition having the large optical anisotropy is preferred for a device having a small cell gap. A large dielectric anisotropy in the composition contributes to a low threshold voltage, a small electric power consumption and a large contrast ratio in the device. Accordingly, the large dielectric anisotropy is preferred. A large specific resistance in the composition contributes to a large voltage holding ratio and the large contrast ratio in the device. Accordingly, a composition having the large specific resistance at room temperature and also at a temperature close to the maximum temperature of the nematic phase in an initial stage is preferred. The composition having the large specific resistance at room temperature and also at a temperature close to the maximum temperature of the nematic phase even after the device has been used for a long period of time is preferred. Stability of the composition to ultraviolet light and heat relates to a service life of the liquid crystal display device. In the case where the stability is high, the device has a long service life. Such characteristics are preferred for an AM device use in a liquid crystal projector, a liquid crystal television and so forth.

A composition having a positive dielectric anisotropy is used in an AM device having the TN mode. A composition having a negative dielectric anisotropy is used in an AM device having the VA mode. A composition having the positive or negative dielectric anisotropy is used in an AM device having the IPS mode or the FFS mode. In an AM device having the polymer sustained alignment (PSA) mode, a composition having the positive or negative dielectric anisotropy is used. Examples of the liquid crystal composition having the positive dielectric anisotropy are disclosed in Patent literature Nos. 1 to 5 described below.

### CITATION LIST

### Patent Literature

Patent literature No. 1: KR 10-2013-0102012 A.

Patent literature No. 2: JP 2012-7163 A.

Patent literature No. 3: WO 2010-022891 A1.

Patent literature No. 4: WO 2013-034227 A1.

Patent literature No. 5: JP 2001-316346 A.

In a liquid crystal display device technology, major problems are almost being solved. A problem of a view angle is improved by using a multidomain structure and an optical compensation film, a problem of a response time is improved by controlling a pretilt angle of a liquid crystal by operating reactive monomer and utilizing an overdrive method, and a problem of a contrast is decreased by a local dimming technology of backlight. However, if the liquid crystal display device technology is seen in more detail, problems still remained in the technology such as a technology of decreasing production cost and a flexible display technology. As an activity solving the problems, a polymer-dispersed liquid crystal (PDLC), a polymer network liquid crystal (PNLC), a pixel-isolated liquid crystal (PILC) or the like have been studied, but not solved yet.

As a means to solve the problems, a nanoencapsulated liquid crystal display device is studied. The liquid crystal display device technology which combined with the IPS mode has the following features: (1) a cost-benefit performance is high because no need an alignment layer in cell production process, and no assembly process exists due to single-sided substrate structure; (2) a state where no voltage is applied has an optical isotropy because of a particle size effect of an extremely small liquid crystal nanocapsule fixed to a nanoencapsulated layer; and (3) a good compatibility with a flexible display is shown because the production is performed by a printing method of the liquid crystal nanocapsule to the single-sided substrate, in place of requiring a conventional liquid crystal injection process. The nanoencapsulated liquid crystal display device shows the electric field induced transition from the optical isotropy state to an anisotropic state based on the Kerr effect. In order to obtain the Kerr effect as larger as possible, a liquid crystal showing a nematic phase having a large optical anisotropy and a large dielectric anisotropy is suitable.

Moreover, use in a liquid crystal lens that allows switching of display between 2D and 3D is also considered as a device requiring such a large optical anisotropy and a large dielectric anisotropy. Specific examples of a technology for the liquid crystal display device that allows switching of display between 2D and 3D include (1) a liquid crystal barrier type and (2) a liquid crystal lens type. The liquid crystal barrier type is easy to produce, and also easy to switch display between 2D and 3D. However, the liquid crystal barrier type has a disadvantage in which luminance of 3D image is reduced by 50% or more by reduction of the luminance caused by a liquid crystal barrier. The liquid crystal lens type is expected as a promising device without such a disadvantage.

### SUMMARY OF INVENTION

### Technical Problem

One of aims of the invention is to provide a liquid crystal composition satisfying at least one of characteristics such as a high maximum temperature of a nematic phase, a low minimum temperature of the nematic phase, a large optical anisotropy, a large positive dielectric anisotropy and a high stability to ultraviolet light. Another aim is to provide a liquid crystal composition having a suitable balance regarding at least two of the characteristics. A further aim is to provide a liquid crystal display device including such a composition. A still further aim is to provide a liquid crystal display device in which such a liquid crystal composition is encapsulated. A still further aim is to provide a liquid crystal display device serving as a constituent of a display device in which such a liquid crystal composition allows switching of display between 2D and 3D.

### Solution to Problem

The invention concerns a liquid crystal composition that contains at least one compound selected from the group of compounds represented by formula (1) as a first component and at least one compound selected from the group of compounds represented by formula (2) as a second component, wherein a proportion of a compound having cyano is less than 3% by weight based on a total of the liquid crystal composition, and liquid crystal display device including the composition:

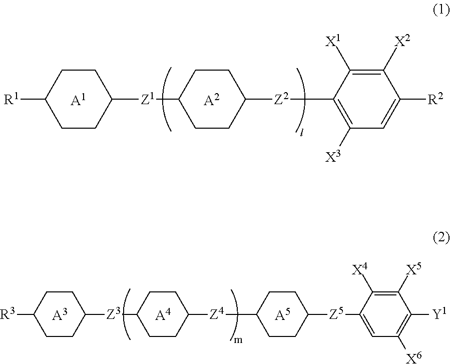

wherein, in formula (1) and formula (2), R¹, R² and R³ are independently alkyl having 1 to 12 carbons, alkoxy having 1 to 12 carbons or alkenyl having 2 to 12 carbons; rings A¹, A², A³, A⁴ and A⁵ are independently 1,4-cyclohexylene, 1,4-phenylene, 2-fluoro-1,4-phenylene, 2,5-difluoro-1,4-phenylene, 2,6-difluoro-1,4-phenylene, pyridine-2,5-diyl, pyrimidine-2,5-diyl, 1,3-dioxane-2,5-diyl or tetrahydropyran-2,5-diyl; Z¹, Z², Z³, Z⁴ and Z^{s5} are independently a single bond, ethylene, vinylene, methyleneoxy, carbonyloxy, difluoromethyleneoxy, tolan or tetrafluoroethylene, in which at least one of Z¹ and Z² is tolan; X¹, X², X³, X⁴, X⁵ and X⁶ are independently hydrogen or fluorine, in which X¹ and X² are not fluorine simultaneously, and X⁴ and X⁵ are not fluorine simultaneously; Y¹ is fluorine, chlorine, alkyl having 1 to 12 carbons in which at least one piece of hydrogen is replaced by halogen, alkoxy having 1 to 12 carbons in which at least one piece of hydrogen is replaced by halogen, or alkenyl having 2 to 12 carbons in which at least one piece of hydrogen is replaced by halogen; and l is 1 or 2, m is 0, 1 or 2, and when l and m represent 2, a plurality of ring A², ring A⁴, Z² and Z⁴ may be identical or different, respectively.

### Advantageous Effects of Invention

An advantage of the invention is a liquid crystal composition satisfying at least one of characteristics such as a high maximum temperature of a nematic phase, a low minimum temperature of the nematic phase, a large optical anisotropy, a large positive dielectric anisotropy and a high stability to ultraviolet light. Another advantage is a liquid crystal composition having a suitable balance regarding at least two of the characteristics. A further advantage is a liquid crystal display device including such a liquid crystal composition. A still further advantage is a liquid crystal display device in which such a liquid crystal composition is encapsulated. A still further advantage is a liquid crystal display device serving as a constituent of a display device in which such a liquid crystal composition allows switching of display between 2D and 3D.

### DESCRIPTION OF EMBODIMENTS

Usage of terms herein is as described below. Terms “liquid crystal composition” and “liquid crystal display device” may be occasionally abbreviated as “composition” and “device,” respectively. “Liquid crystal display device” is a generic term for a liquid crystal display panel and a liquid crystal display module. “Liquid crystal compound” is a generic term for a compound having a liquid crystal phase such as a nematic phase and a smectic phase, and a compound having no liquid crystal phase but to be mixed with a composition for the purpose of adjusting characteristics such as a temperature range of the nematic phase, viscosity and a dielectric anisotropy. The compound has a six-membered ring such as 1,4-cyclohexylene and 1,4-phenylene, and has rod-like molecular structure. “Polymerizable compound” is a compound to be added for the purpose of forming a polymer in the composition. At least one compound selected from the group of compounds represented by formula (1) may be occasionally abbreviated as “compound (1).” “Compound (1)” means one compound or two or more compounds represented by formula (1). A same rule applies also to any other compound represented by any other formula. An expression “at least one piece of” in the context of “replaced by” means that not only a position but also the number thereof may be selected without restriction.

The liquid crystal composition is prepared by mixing a plurality of liquid crystal compounds. A proportion (content) of the liquid crystal compounds is expressed in terms of weight percent (% by weight) based on the weight of the liquid crystal composition. An additive such as an optically active compound, an antioxidant, an ultraviolet light absorber, a dye, an antifoaming agent, the polymerizable compound, a polymerization initiator and a polymerization inhibitor is added to the liquid crystal composition when necessary. A proportion (amount of addition) of the additive is expressed in terms of weight percent (% by weight) based on the weight of the liquid crystal composition in a manner similar to the proportion of the liquid crystal compound. Weight parts per million (ppm) may be occasionally used. A proportion of the polymerization initiator and the polymerization inhibitor is exceptionally expressed based on the weight of the polymerizable compound.

“Maximum temperature of the nematic phase” may be occasionally abbreviated as “maximum temperature.” “Minimum temperature of the nematic phase” may be occasionally abbreviated as “minimum temperature.” An expression “having a large specific resistance” means that the composition has a large specific resistance at room temperature and also at a temperature close to the maximum temperature of the nematic phase in an initial stage, and the composition has the large specific resistance at room temperature and also at a temperature close to the maximum temperature of the nematic phase even after the device has been used for a long period of time. An expression “having a large voltage holding ratio” means that the device has a large voltage holding ratio at room temperature and also at a temperature close to the maximum temperature of the nematic phase in an initial stage, and the device has the large voltage holding ratio at room temperature and also at a temperature close to the maximum temperature of the nematic phase even after the device has been used for a long period of time.

An expression “at least one piece of ‘A’ may be replaced by ‘B’” means that the number of ‘A’ is arbitrary. When the number of ‘A’ is 1, a position of ‘A’ is arbitrary, and also when the number of ‘A’ is 2 or more, positions thereof can be selected without restriction. A same rule applies also to an expression “at least one piece of ‘A’ is replaced by ‘B’.”

A symbol of terminal group R¹¹ is used in a plurality of compounds in chemical formulas of component compounds. In the compounds, two groups represented by two pieces of arbitrary R¹¹ may be identical or different. In one case, for example, R¹¹ of compound (1-1) is ethyl and R¹¹ of compound (1-1-1) is ethyl. In another case, for example, R¹¹ of compound (1) is ethyl and R¹¹ of compound (1-1-1) is propyl. A same rule applies also to a symbol such as R²¹, R³¹, R³², R⁴ and R⁵. In formula (1), when l is 2, two of rings A² exists. In the compound, two rings represented by two of rings A² may be identical or different. A same rule applies also to Z², ring A⁴, Z⁴, ring A⁴¹, Z⁴¹, ring A⁴², Z⁴², ring A⁷, Z⁷ or the like.

Then, 2-fluoro-1,4-phenylene means two divalent groups described below. In a chemical formula, fluorine may be leftward (L) or rightward (R). A same rule applies also to a divalent group of asymmetrical ring such as 2,5-difluoro-1,4-phenylene, 2,6-difluoro-1,4-phenylene, pyridine-2,5-diyl, pyrimidine-2,5-diyl, 1,3-dioxane-2,5-diyl and tetrahydropyran-2,5-diyl.

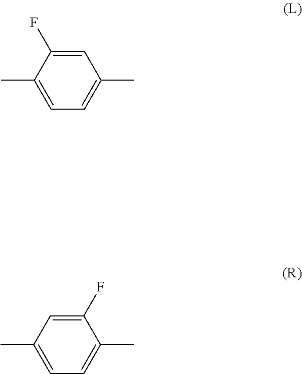

The invention includes items described below.

Item 1. A liquid crystal composition that contains at least one compound selected from the group of compounds represented by formula (1) as a first component and at least one compound selected from the group of compounds represented by formula (2) as a second component, wherein a proportion of a compound having cyano is less than 3% by weight based on a total of the liquid crystal composition:

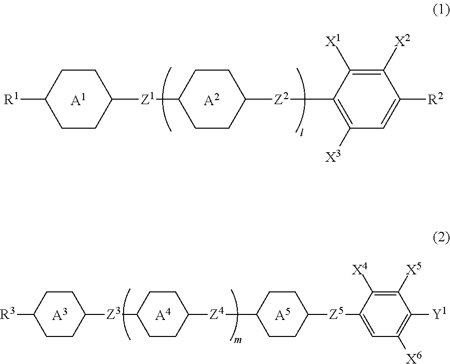

wherein, in formula (1) and formula (2), R¹, R² and R³ are independently alkyl having 1 to 12 carbons, alkoxy having 1 to 12 carbons or alkenyl having 2 to 12 carbons; rings A¹, A², A³, A⁴ and A⁵ are independently 1,4-cyclohexylene, 1,4-phenylene, 2-fluoro-1,4-phenylene, 2,5-difluoro-1,4-phenylene, 2,6-difluoro-1,4-phenylene, pyridine-2,5-diyl, pyrimidine-2,5-diyl, 1,3-dioxane-2,5-diyl or tetrahydropyran-2,5-diyl; Z¹, Z², Z³, Z⁴ and Z⁵ are independently a single bond, ethylene, vinylene, methyleneoxy, carbonyloxy, difluoromethyleneoxy, tolan or tetrafluoroethylene, in which at least one of Z¹ and Z² is tolan; X¹, X², X³, X⁴, X⁵ and X⁶ are independently hydrogen or fluorine, in which X¹ and X² are not fluorine simultaneously, and X⁴ and X⁵ are not fluorine simultaneously; Y¹ is fluorine, chlorine, alkyl having 1 to 12 carbons in which at least one piece of hydrogen is replaced by halogen, alkoxy having 1 to 12 carbons in which at least one piece of hydrogen is replaced by halogen, or alkenyl having 2 to 12 carbons in which at least one piece of hydrogen is replaced by halogen; and l is 1 or 2, m is 0, 1 or 2, and when l and m represent 2, a plurality of ring A², ring A⁴, Z² and Z⁴ may be identical or different, respectively.

Item 2. The liquid crystal composition according to item 1, wherein a proportion of the first component is in the range of 20% by weight to 70% by weight, and a proportion of the second component is in the range of 25% by weight to 75% by weight, based on the weight of the liquid crystal composition.

Item 3. The liquid crystal composition according to item 1 or 2, containing at least one compound selected from the group of compounds represented by formula (1-1) as the first component and at least one compound selected from the group of compounds represented by formula (2-1) as the second component:

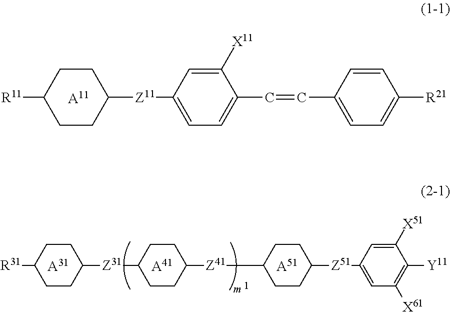

wherein, in formula (1-1) and formula (2-1), R¹¹, R²¹ and R³¹ are independently alkyl having 1 to 12 carbons, alkoxy having 1 to 12 carbons or alkenyl having 2 to 12 carbons; ring A¹¹ is 1,4-cyclohexylene, 1,4-phenylene, 2-fluoro-1,4-phenylene, 2,5-difluoro-1,4-phenylene or 2,6-difluoro-1,4-phenylene; ring A³¹ is 1,4-phenylene, 2-fluoro-1,4-phenylene, 2,6-difluoro-1,4-phenylene, pyridine-2,5-diyl, pyrimidine-2,5-diyl, 1,3-dioxane-2,5-diyl or tetrahydropyran-2,5-diyl; ring A⁴¹ and ring A⁵¹ are independently 1,4-phenylene, 2-fluoro-1,4-phenylene or 2,6-difluoro-1, 4-phenylene; Z¹¹, Z³¹, Z⁴¹ and Z⁵¹ are independently a single bond, ethylene, vinylene, methyleneoxy, carbonyloxy, difluoromethyleneoxy, tolan or tetrafluoroethylene, in which at least one of Z³¹, Z⁴¹ and Z⁵¹ is difluoromethyleneoxy; X¹¹, X⁵¹ and X⁶¹ are independently hydrogen or fluorine; Y¹¹ is fluorine, chlorine, alkyl having 1 to 12 carbons in which at least one piece of hydrogen is replaced by halogen, alkoxy having 1 to 12 carbons in which at least one piece of hydrogen is replaced by halogen, or alkenyl having 2 to 12 carbons in which at least one piece of hydrogen is replaced by halogen; and m¹ is 0, 1 or 2, and when m¹ represents 2, a plurality of ring A⁴¹ and Z⁴¹ may be identical or different, respectively.

Item 4. The liquid crystal composition according to any one of items 1 to 3, containing at least one compound selected from the group of compounds represented by formula (1-1-1) to formula (1-1-13) as the first component:

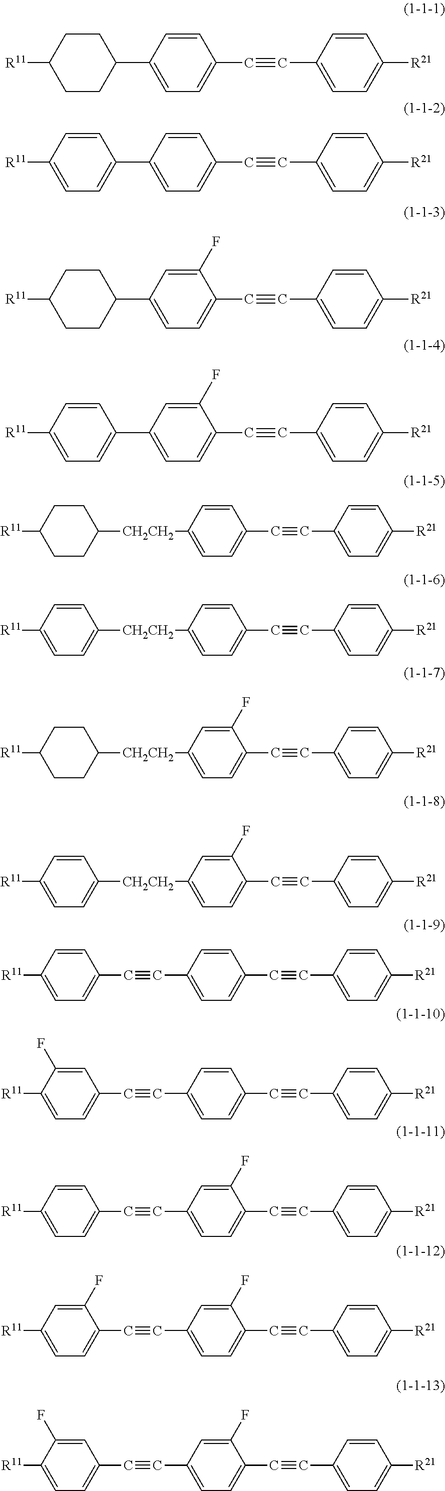

wherein, in the formulas, R¹¹ and R²¹ are independently alkyl having 1 to 12 carbons, alkoxy having 1 to 12 carbons or alkenyl having 2 to 12 carbons.

Item 5. The liquid crystal composition according to any one of items 1 to 4, wherein a proportion of a compound represented by formula (1-1) described in item 2 is in the range of 10% by weight to 50% by weight based on the weight of the liquid crystal composition.

Item 6. The liquid crystal composition according to any one of items 1 to 5, containing at least one compound selected from the group of compounds represented by formula (2-1-1) to formula (2-1-12) as the second component:

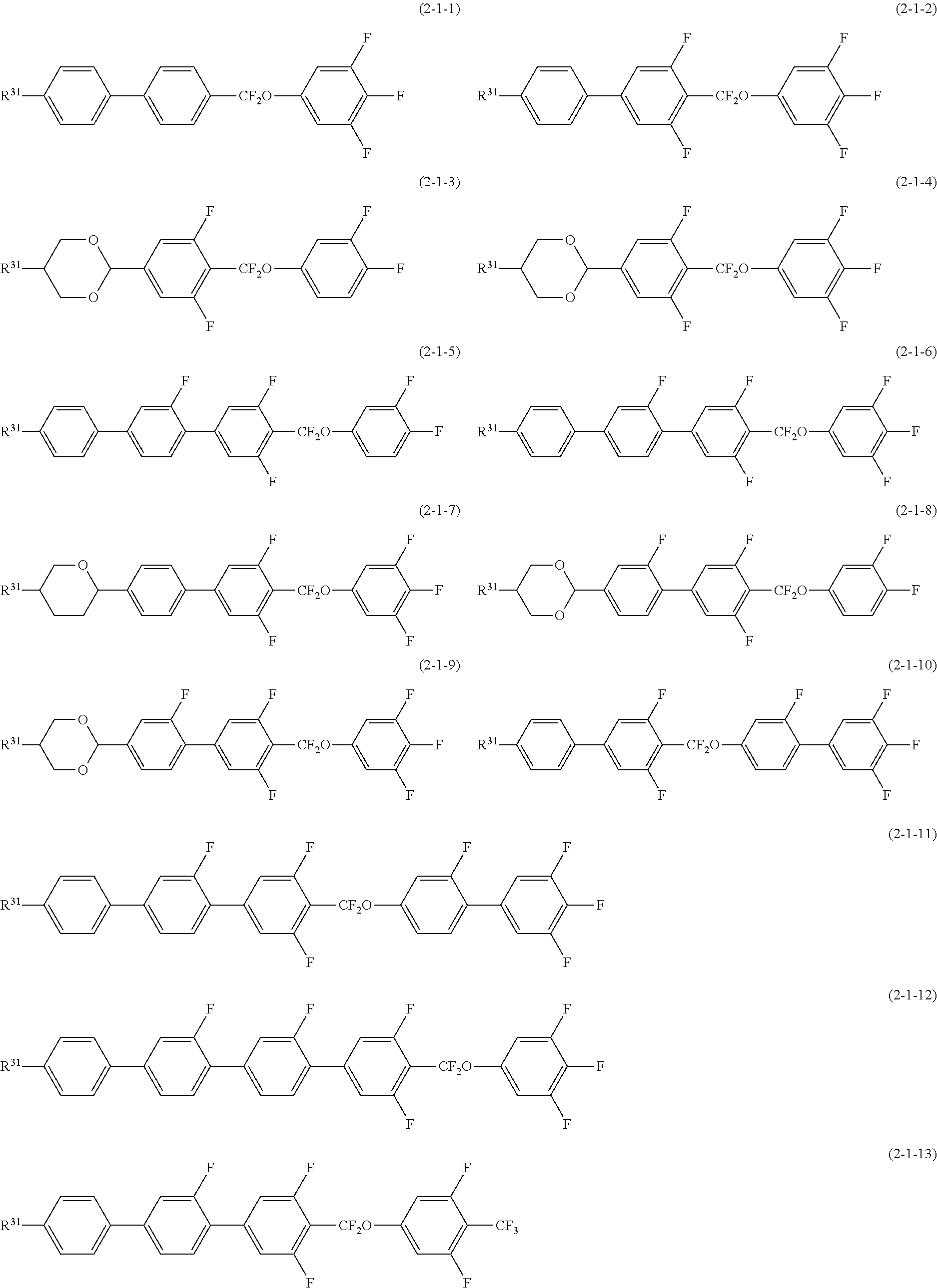

having 1 to 12 carbons or alkeny having 2 to 12 carbons.)

Item 7. The liquid crystal composition according to any one of items 1 to 6, wherein a proportion of a compound represented by formula (2-1) described in item 2 is in the range of 25% by weight to 70% by weight based on the weight of the liquid crystal composition.

Item 8. The liquid crystal composition according to any one of items 1 to 7, containing at least one compound selected from the group of compounds represented by formula (2-2) as the second component:

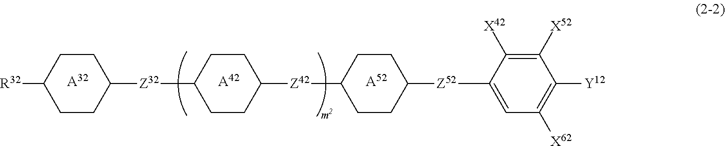

wherein, in formula (2-2), R³² is alkyl having 1 to 12 carbons, alkoxy having 1 to 12 carbons or alkenyl having 2 to 12 carbons; ring A³² is 1,4-phenylene, 2-fluoro-1,4-phenylene, 2,6-difluoro-1,4-phenylene, pyridine-2,5-diyl, pyrimidine-2,5-diyl, 1,3-dioxane-2,5-diyl or tetrahydropyran-2,5-diyl; ring A⁴² and ring A⁵² are independently 1,4-phenylene, 2-fluoro-1,4-phenylene or 2, 6-difluoro-1, 4-phenylene; Z³², Z⁴² and Z⁵² are independently a single bond, ethylene, vinylene, methyleneoxy, carbonyloxy, tolan or tetrafluoroethylene; X⁴², X⁵² and X⁶² are independently hydrogen or fluorine, in which X⁴² and X⁵² are not fluorine simultaneously; Y¹² is fluorine, chlorine, alkyl having 1 to 12 carbons in which at least one piece of hydrogen is replaced by halogen, alkoxy having 1 to 12 carbons in which at least one piece of hydrogen is replaced by halogen, or alkenyl having 2 to 12 carbons in which at least one piece of hydrogen is replaced by halogen; and m² is 0, 1 or 2, and when m² represents 2, a plurality of ring A⁴² and Z⁴² may be identical or different, respectively.

Item 9. The liquid crystal composition according to any one of items 1 to 8, containing at least one compound selected from the group of compounds represented by formula (2-2-1) to formula (2-2-12) as the second component:

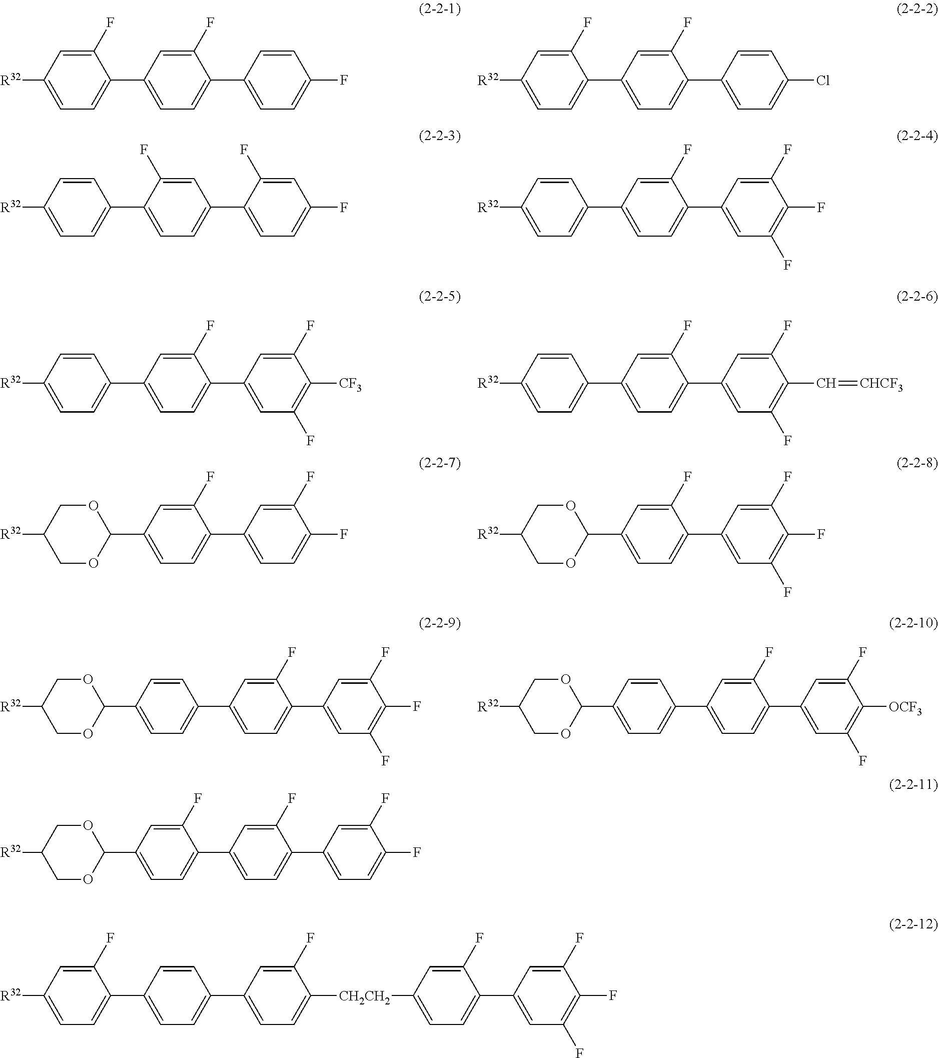

wherein, in the formulas, R³² is alkyl having 1 to 12 carbons, alkoxy having 1 to 12 carbons or alkenyl having 2 to 12 carbons.

Item 10. The liquid crystal composition according to any one of items 1 to 9, wherein a proportion of a compound represented by formula (2-2) is in the range of 0% by weight to 50% by weight based on the weight of the liquid crystal composition.

Item 11. The liquid crystal composition according to any one of items 1 to 10, further containing at least one compound selected from the group of compounds represented by formula (3) as a third component:

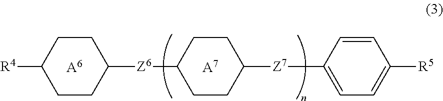

wherein, in formula (3), R⁴ and R⁵ are independently alkyl having 1 to 12 carbons, alkoxy having 1 to 12 carbons or alkenyl having 2 to 12 carbons; ring A⁶ or ring A⁷ is independently 1,4-cyclohexylene, 1,4-phenylene, 2-fluoro-1,4-phenylene, 2,5-difluoro-1,4-phenylene or 2,6-difluoro-1,4-phenylene; Z⁶ is a single bond, ethylene, vinylene, methyleneoxy, carbonyloxy, difluoromethyleneoxy, tolan or tetrafluoroethylene; Z⁷ is independently a single bond, ethylene, vinylene, methyleneoxy, carbonyloxy, difluoromethyleneoxy or tetrafluoroethylene; and n is 0, 1 or 2, and when n is 1 or 2, Z⁶ is not tolan, and when n represents 2, a plurality of ring A⁷ and Z⁷ may be identical or different, respectively.

Item 12. The liquid crystal composition according to any one of items 1 to 11, containing at least one compound selected from the group of compounds represented by formula (3-1) to formula (3-12) as the third component:

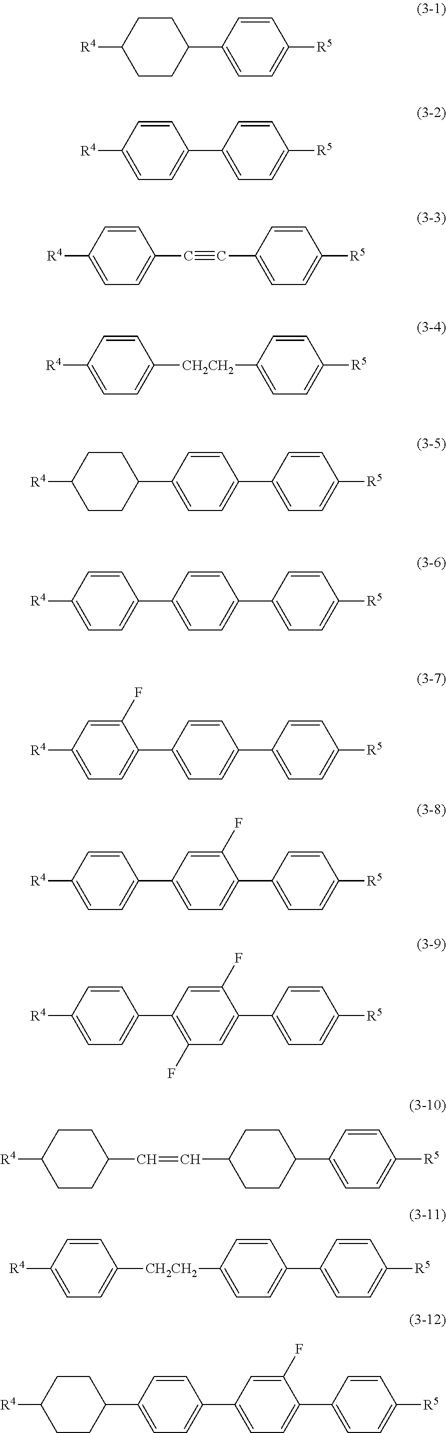

wherein, in the formulas, R⁴ and R⁵ are independently alkyl having 1 to 12 carbons, alkoxy having 1 to 12 carbons or alkenyl having 2 to 12 carbons.

Item 13. The liquid crystal composition according to any one of items 1 to 12, wherein a proportion of the third component is in the range of 10% by weight to 55% by weight based on the weight of the liquid crystal composition.

Item 14. The liquid crystal composition according to any one of items 1 to 13, wherein an optical anisotropy (measured at 25° C.) at a wavelength of 589 nanometers is in the range of 0.20 to 0.35, and a dielectric anisotropy (measured at 25° C.) at a frequency of 1 kHz is in the range of 8 to 40.

Item 15. A liquid crystal display device, including the liquid crystal composition according to any one of items 1 to 14.

Item 16. The liquid crystal display device according to item 15, wherein the liquid crystal composition according to any one of items 1 to 14 is encapsulated.

Item 17. The liquid crystal display device according to item 15, wherein the liquid crystal composition according to any one of items 1 to 14 is used in a display device that allows switching of display between 2D and 3D.

Item 18. Use of the liquid crystal composition according to any one of items 1 to 14 in a liquid crystal display device.

The invention further includes the following items: (a) the composition, further containing at least one additive such as an optically active compound, an antioxidant, an ultraviolet light absorber, a dye, an antifoaming agent, a polymerizable compound, a polymerization initiator and a polymerization inhibitor; (b) an AM device including the composition; (c) the composition further containing a polymerizable compound, and a polymer sustained alignment (PSA) mode AM device including the composition; (d) a polymer sustained alignment (PSA) mode AM device, wherein the device includes the composition, and a polymerizable compound in the composition is polymerized; (e) a device including the composition and having the PC mode, the TN mode, the STN mode, the ECB mode, the OCB mode, the IPS mode, the VA mode, the FFS mode or the FPA mode; (f) a transmissive device including the composition; (g) use of the composition as the composition having the nematic phase; and (h) use as an optically active composition by adding the optically active compound to the composition.

The composition of the invention will be described in the following order. First, a constitution of the component compounds in the composition will be described. Second, main characteristics of the component compounds and main effects of the compounds on the composition will be described. Third, a combination of components in the composition, a preferred proportion of the components and the basis thereof will be described. Fourth, a preferred embodiment of the component compounds will be described. Fifth, a preferred component compounds will be described. Sixth, an additive that may be added to the composition will be described. Last, an application of the composition will be described.

First, the constitution of the component compounds in the composition will be described. The composition of the invention is classified into composition A and composition B. Composition A may further contain any other liquid crystal compound, an additive or the like in addition to the liquid crystal compound selected from compound (1), compound (2) and compound (3). “Any other liquid crystal compound” means a liquid crystal compound different from compound (1), compound (2) and compound (3). Such a compound is mixed with the composition for the purpose of further adjusting the characteristics. The additive is the optically active compound, the antioxidant, the ultraviolet light absorber, the dye, the antifoaming agent, the polymerizable compound, the polymerization initiator, the polymerization inhibitor or the like.

Composition B consists essentially of liquid crystal compounds selected from compound (1), compound (2) and compound (3) An expression “essentially” means that the composition may contain the additive, but contains no any other liquid crystal compound. Composition B has a smaller number of components than composition A has. Composition B is preferred to composition A in view of cost reduction. Composition A is preferred to composition B in view of possibility of further adjusting the characteristics by mixing any other liquid crystal compound.

Second, the main characteristics of the component compounds and the main effects of the compounds on the characteristics of the composition will be described. The main characteristics of the component compounds are summarized in Table 2 on the basis of advantageous effects of the invention. In Table 2, a symbol L stands for “large” or “high,” a symbol M stands for “medium” and a symbol S stands for “small” or “low.” The symbols L, M and S represent a classification based on a qualitative comparison among the component compounds, and 0 (zero) means “a value is nearly zero” or “a value close to zero.”

TABLE 2
Characteristics of Compound

| Compounds | (1) | (2) | (3) |
|---|---|---|---|
| Maximum temperature | M to L | M to L | S to L |
| Viscosity | M | M to L | S to M |
| Optical anisotropy | L | M to L | L |
| Dielectric anisotropy | 0 | M to L | 0 |
| Specific resistance | L | L | L |

Upon mixing the component compounds with the composition, the main effects of the component compounds on the characteristics of the composition are as described below. Compound (1) increases the optical anisotropy. Compound (2) increases the dielectric anisotropy. Compound (3) increases the optical anisotropy, and increases the maximum temperature or decreases the minimum temperature.

Third, the combination of components in the composition, the preferred proportion of the component compounds and the basis thereof will be described. The combination of components in the composition includes a combination of the first component and the second component, and a combination of the first component, the second component and the third component. A preferred combination of components in the composition includes a combination of the first component, the second component and the third component.

Based on the weight of the liquid crystal composition, a preferred proportion of the first component is about 20% by weight or more for increasing the optical anisotropy or increasing the maximum temperature, and about 70% by weight or less for increasing the dielectric anisotropy. A further preferred proportion is in the range of about 25% by weight to about 70% by weight. A particularly preferred proportion is in the range of about 30% by weight to about 65% by weight.

Based on the weight of the liquid crystal composition, a preferred proportion of a compound represented by formula (1-1) in the first component is about 10% by weight or more for increasing the optical anisotropy or increasing the maximum temperature, and about 50% by weight or less for increasing the dielectric anisotropy or decreasing the minimum temperature. A further preferred proportion is in the range of about 10% by weight to 45% by weight. A particularly preferred proportion is in the range of about 10% by weight to 40% by weight.

Based on the weight of the liquid crystal composition, a preferred proportion of the second component is about 25% by weight or more for increasing the dielectric anisotropy or increasing the maximum temperature, and about 75% by weight or less for increasing the optical anisotropy or decreasing the minimum temperature. A further preferred proportion is in the range of about 30% by weight to about 75% by weight. A particularly preferred proportion is in the range of about 35% by weight to about 70% by weight.

Based on the weight of the liquid crystal composition, a preferred proportion of a compound represented by formula (2-1) in the second component is about 25% by weight or more for increasing the dielectric anisotropy or increasing the maximum temperature, and about 70% by weight or less for increasing the optical anisotropy or decreasing the minimum temperature. A further preferred proportion is in the range of about 25% by weight to 65% by weight. A particularly preferred proportion is in the range of about 25% by weight to 60% by weight.

Based on the weight of the liquid crystal composition, a preferred proportion of a compound represented by formula (2-2) in the second component is about 0% by weight or more for increasing the dielectric anisotropy, and about 50% by weight or less for increasing the optical anisotropy or decreasing the minimum temperature. A further preferred proportion is in the range of about 0% by weight to 30% by weight. A particularly preferred proportion is in the range of about 0% by weight to 15% by weight.

Based on the weight of the liquid crystal composition, a preferred proportion of the third component is about 10% by weight or more for increasing the optical anisotropy and increasing the maximum temperature or decreasing the minimum temperature, and about 55% by weight or less for increasing the dielectric anisotropy. A further preferred proportion is in the range of about 10% by weight to about 50% by weight. A particularly preferred proportion is in the range of about 10% by weight to about 45% by weight.

In view of a high stability to ultraviolet light, the composition of the invention preferably contains as few compound having cyano as possible. A proportion of the compound having cyano is preferably less than 3% by weight, further preferably less than 2% by weight, and still further preferably less than 1% by weight based on a total of the liquid crystal composition.

Fourth, the preferred embodiment of the component compounds will be described. R¹, R², R³, R¹¹, R²¹, R³¹, R³², R⁴ and R⁵ are independently alkyl having 1 to 12 carbons, alkoxy having 1 to 12 carbons or alkenyl having 2 to 12 carbons. Preferred R¹, R², R³, R¹¹, R²¹, R³¹, R³², R⁴ and R⁵ are alkyl having 1 to 12 carbons for increasing stability to ultraviolet light or heat.

Preferred alkyl is methyl, ethyl, propyl, butyl, pentyl, hexyl, heptyl or octyl. Further preferred alkyl is ethyl, propyl, butyl, pentyl or heptyl for decreasing the viscosity.

Preferred alkoxy is methoxy, ethoxy, propoxy, butoxy, pentyloxy, hexyloxy or heptyloxy. Further preferred alkoxy is methoxy or ethoxy for decreasing the viscosity.

Preferred alkenyl is vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl or 5-hexenyl. Further preferred alkenyl is vinyl, 1-propenyl, 3-butenyl or 3-pentenyl for decreasing the viscosity. A preferred configuration of —CH═CH— in the alkenyl depends on a position of a double bond. Trans is preferred in alkenyl such as 1-propenyl, 1-butenyl, 1-pentenyl, 1-hexenyl, 3-pentenyl and 3-hexenyl for decreasing the viscosity, for instance. Cis is preferred in alkenyl such as 2-butenyl, 2-pentenyl and 2-hexenyl. In the alkenyl, straight-chain alkenyl is preferred to branched-chain alkenyl.

Then, l is 1 or 2. Preferred l is 1 for increasing the maximum temperature. Then, m¹ is 0, 1 or 2. Preferred m is 1 for increasing the dielectric anisotropy or increasing the maximum temperature. Then, m¹ is 0, 1 or 2. Preferred m is 1 for increasing the dielectric anisotropy or increasing the maximum temperature. Then, m² is 0, 1 or 2. Preferred m² is 0 for increasing the dielectric anisotropy or decreasing the minimum temperature. Then, n is 0, 1 or 2. Preferred n is 0 for decreasing the minimum temperature.

Z¹, Z², Z¹¹ and Z⁶ are independently a single bond, ethylene, vinylene, methyleneoxy, carbonyloxy, difluoromethyleneoxy, tolan or tetrafluoroethylene. Preferred Z¹, Z², Z¹¹ and Z⁶ are independently a single bond or tolan for increasing the optical anisotropy. Z⁷ is a single bond, ethylene, vinylene, methyleneoxy, carbonyloxy, difluoromethyleneoxy or tetrafluoroethylene. Preferred Z⁷ is independently a single bond for increasing the optical anisotropy. Z³, Z⁴, Z⁵, Z³¹, Z⁴¹ or Z⁵¹ is independently a single bond, ethylene, vinylene, methyleneoxy, carbonyloxy, difluoromethyleneoxy, tolan or tetrafluoroethylene. Preferred Z³, Z⁴, Z⁵, Z³¹, Z⁴¹ and Z⁵¹ are difluoromethyleneoxy for increasing the dielectric anisotropy, and a single bond for increasing the specific resistance. Z³², Z⁴² and Z⁵² are independently a single bond, ethylene, vinylene, methyleneoxy, carbonyloxy, tolan or tetrafluoroethylene. Preferred Z³², Z⁴² and Z⁵² are a single bond for increasing the specific resistance.

Ring A¹, ring A², ring A³, ring A⁴ and ring A⁵ are independently 1,4-cyclohexylene, 1,4-phenylene, 2-fluoro-1,4-phenylene, 2,5-difluoro-1,4-phenylene, 2,6-difluoro-1,4-phenylene, pyridine-2,5-diyl, pyrimidine-2,5-diyl, 1,3-dioxane-2,5-diyl or tetrahydropyran-2, 5-diyl. Preferred ring A¹, ring A², ring A³, ring A⁴ and ring A⁵ are 1,4-phenylene, 2-fluoro-1,4-phenylene, 2,5-difluoro-1,4-phenylene or 2,6-difluoro-1,4-phenylene for increasing the optical anisotropy. Ring A¹¹, ring A⁶ and ring A⁷ are independently 1,4-cyclohexylene, 1,4-phenylene, 2-fluoro-1,4-phenylene, 2,5-difluoro-1,4-phenylene or 2,6-difluoro-1,4-phenylene. Preferred ring A¹¹, ring A⁶ and ring A⁷ are 1,4-phenylene or 2-fluoro-1,4-phenylene for increasing the optical anisotropy. Ring A³¹ and ring A³² are independently 1,4-phenylene, 2-fluoro-1,4-phenylene, 2,6-difluoro-1,4-phenylene, pyridine-2,5-diyl, pyrimidine-2,5-diyl, 1,3-dioxane-2,5-diyl or tetrahydropyran-2,5-diyl. Preferred ring A³¹ and ring A³² are 1,4-phenylene, 2-fluoro-1,4-phenylene or 2,6-difluoro-1,4-phenylene for increasing the optical anisotropy. Ring A⁴¹, ring A⁵¹, ring A⁴² and ring A⁵² are independently 1,4-phenylene, 2-fluoro-1,4-phenylene or 2,6-difluoro-1,4-phenylene. Preferred ring A⁴, ring A⁵¹, ring A⁴² and ring A⁵² are 1,4-phenylene or 2-fluoro-1,4-phenylene. With regard to a configuration of 1,4-cyclohexylene, trans is preferred to cis for increasing the maximum temperature. Tetrahydropyran-2,5-diyl includes:

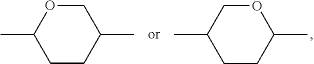

and preferably

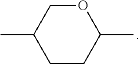

X¹, X², X³, X⁴, X⁵, X⁶, X¹¹, X⁵¹, X⁶¹, X⁴², X⁵² and X⁶² are independently hydrogen or fluorine, in which X¹ and X² are not fluorine simultaneously, or X⁴ and X⁵ are also not fluorine simultaneously. Preferred X⁴, X⁵, X⁶, X⁵¹, X⁶¹, X⁴², X⁵² and X⁶² are fluorine for increasing the dielectric anisotropy.

Y¹, Y¹¹ and Y¹² are independently fluorine, chlorine, alkyl having 1 to 12 carbons in which at least one piece of hydrogen is replaced by halogen, alkoxy having 1 to 12 carbons in which at least one piece of hydrogen is replaced by halogen, or alkenyl having 2 to 12 carbons in which at least one piece of hydrogen is replaced by halogen. Preferred Y¹, Y¹¹ and Y¹² are fluorine for decreasing the minimum temperature.

Fifth, the preferred component compounds will be described. Preferred compound (1-1) includes compound (1-1-1) to compound (1-1-13) as described below.

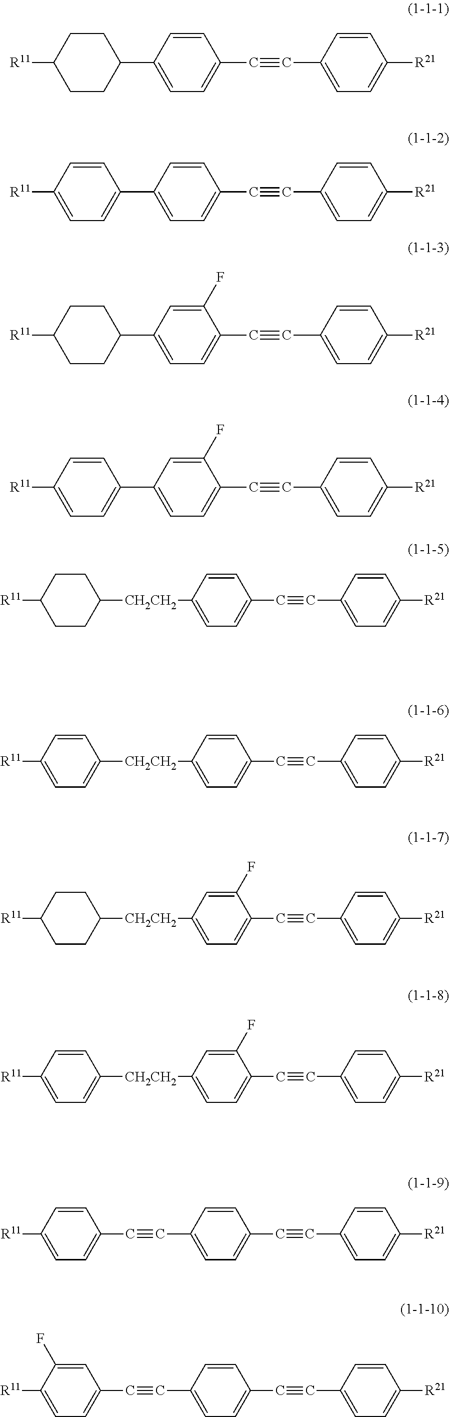

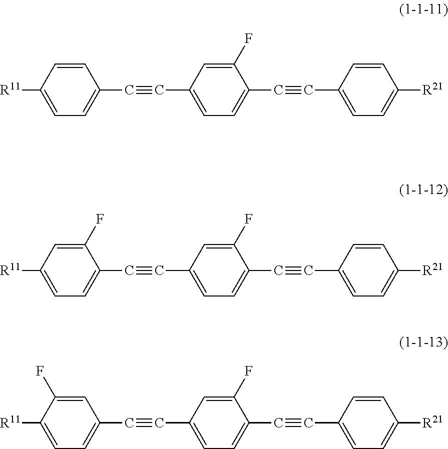

In the compounds, at least one of the first components preferably includes compound (1-1-3), compound (1-1-4) or compound (1-1-5). At least two of first components preferably include a combination of compound (1-1-3) and compound (1-1-5) or a combination of compound (1-1-4) and compound (1-1-5).

Preferred compound (2-1) includes compound (2-1-1) to compound (2-1-13) described above.

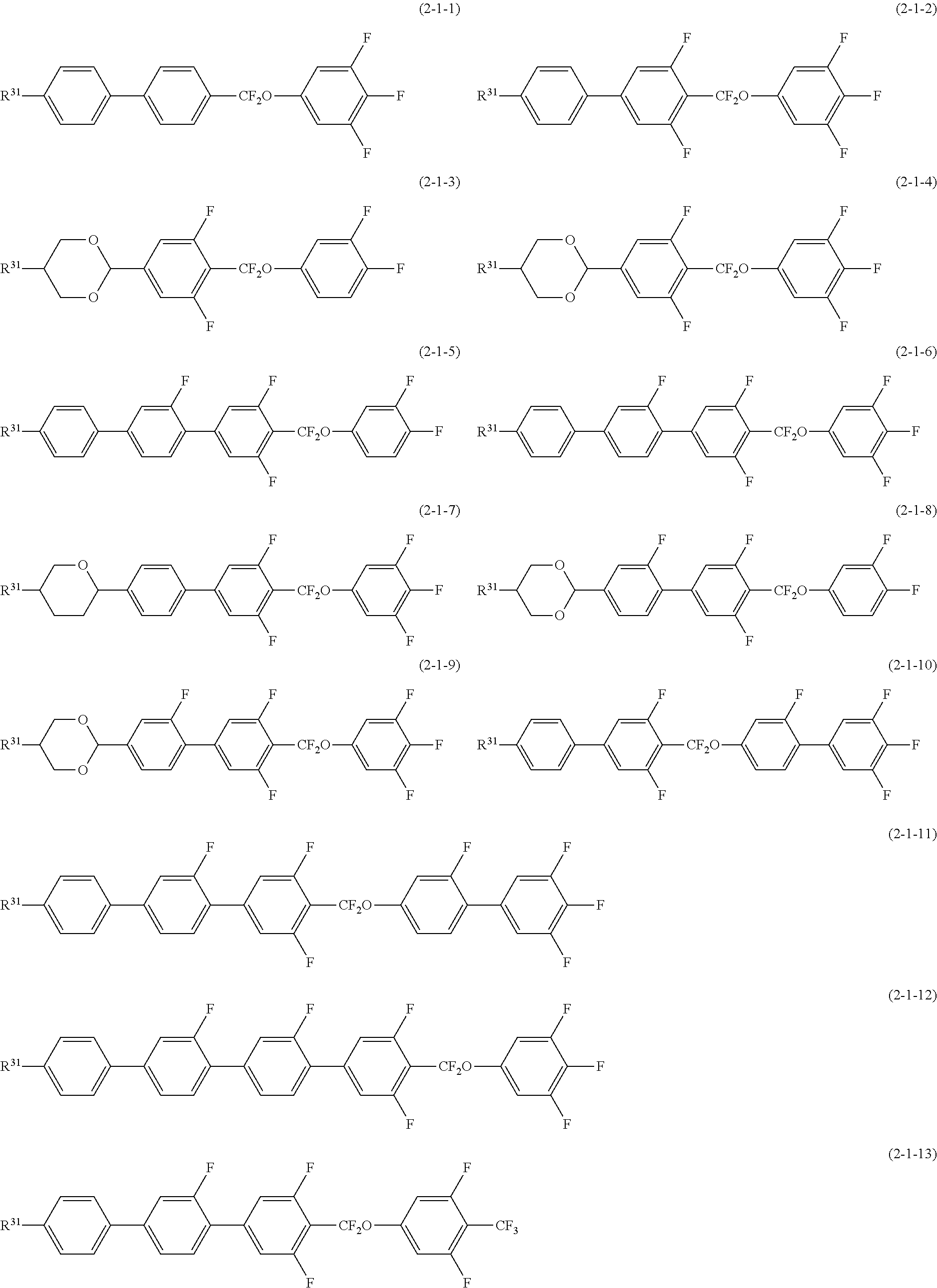

In the compounds, at least one of compounds represented by formula (2-1) in the second components preferably includes compound (2-1-2), compound (2-1-5), compound (2-1-6) or compound (2-1-10). At least two of compounds represented by formula (2-1) in the second components preferably include a combination of compound (2-1-2) and compound (2-1-6), a combination of compound (2-1-5) and compound (2-1-6) or a combination of compound (2-1-6) and compound (2-1-10).

Preferred compound (2-2) includes compound (2-2-1) to compound (2-2-12) as described above.

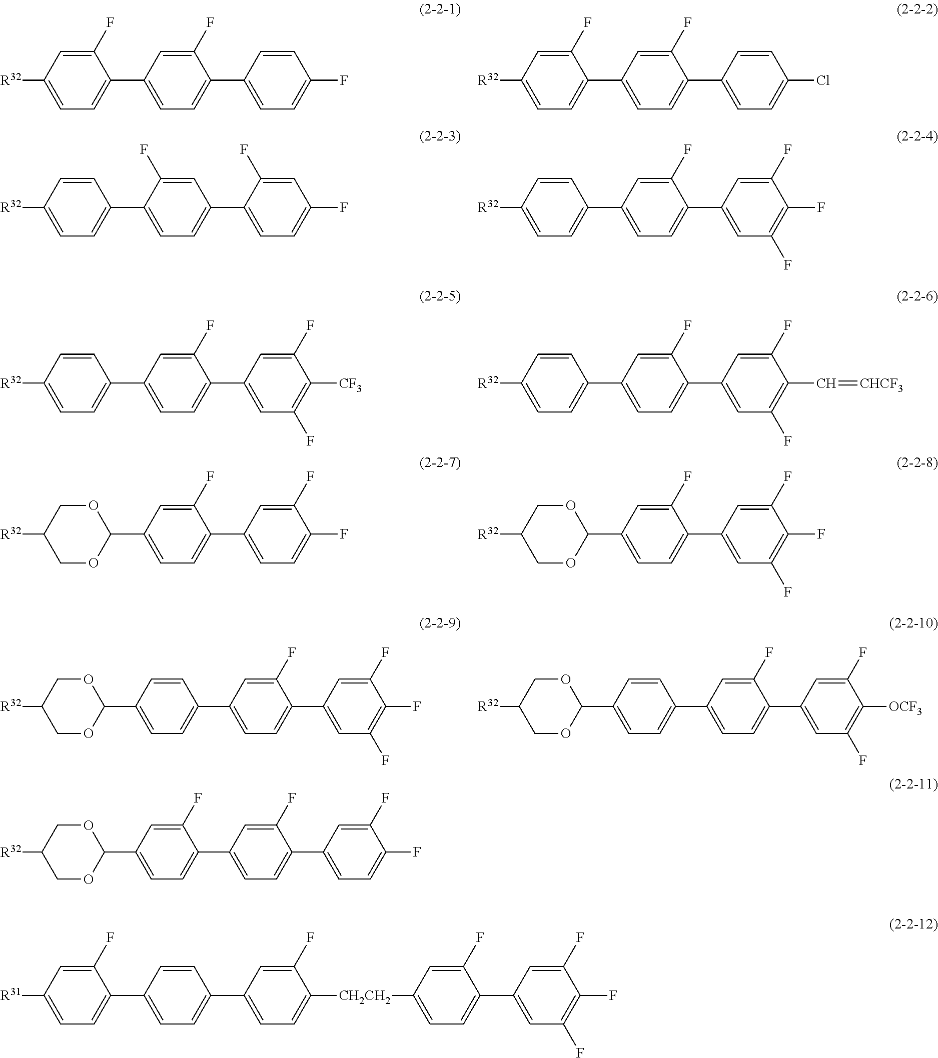

In the compounds, at least one of compounds represented by formula (2-2) in the second components preferably includes compound (2-2-4) or compound (2-2-5). At least two of compounds represented by formula (2-2) in the second components preferably include a combination of compound (2-2-4) and compound (2-2-5).

Preferred compound (3) includes compound (3-1) to compound (3-12) as described below.

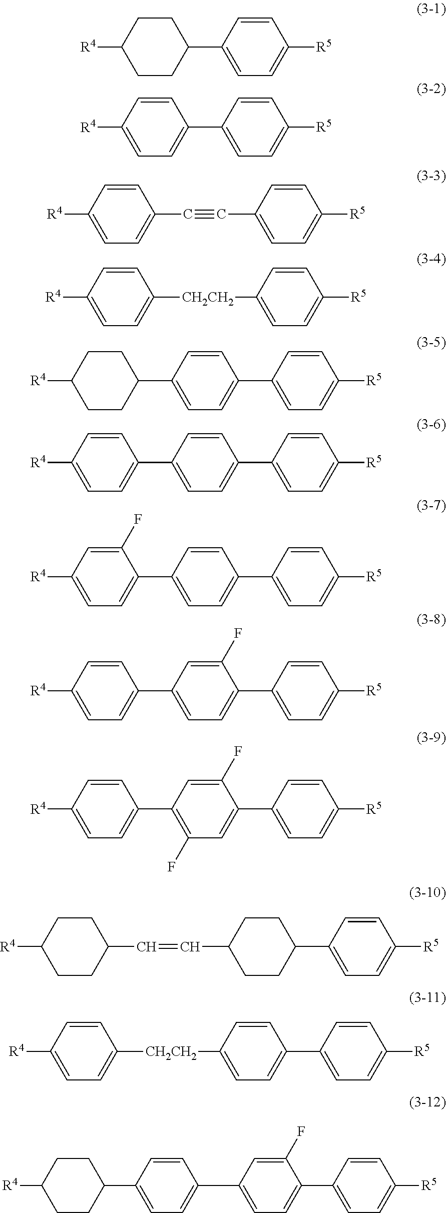

In the compounds, at least one of the third components preferably includes compound (3-2), compound (3-3), compound (3-8), compound (3-9) or compound (3-12). At least two of the third components preferably include a combination of compound (3-3) and compound (3-8), a combination of compound (3-3) and compound (3-8) or a combination of compound (3-3) and compound (3-12).

Sixth, the additive that may be added to the composition will be described. Such an additive includes the optically active compound, the antioxidant, the ultraviolet light absorber, the dye, the antifoaming agent, the polymerizable compound, the polymerization initiator and the polymerization inhibitor. Hereinafter, a mixing proportion of the additives means a proportion (weight) based on the weight of the liquid crystal composition unless otherwise noted.

The optically active compound is added to the composition for the purpose of inducing helical structure in a liquid crystal to give a twist angle. Examples of such a compound include compound (5-1) to compound (5-5). A preferred proportion of the optically active compound is about 5% by weight or less. A further preferred proportion is in the range of about 0.01% by weight to about 2% by weight.

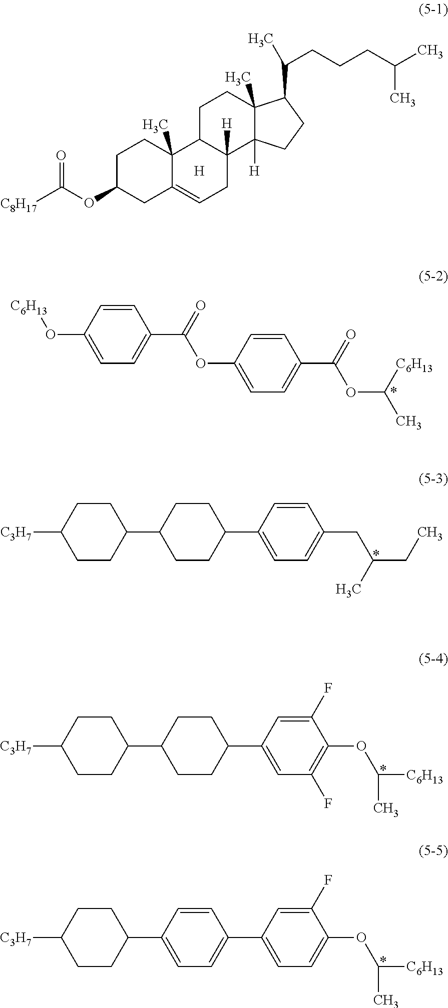

The antioxidant is added to the composition for preventing a decrease in the specific resistance caused by heating in air, or for maintaining a large voltage holding ratio at room temperature and also at the temperature close to the maximum temperature even after the device has been used for a long period of time. Preferred examples of the antioxidant include compound (6) where t is an integer from 1 to 9 or the like.

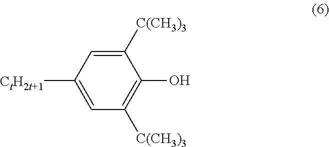

In compound (6), preferred t is 1, 3, 5, 7 or 9. Further preferred t is 7. Compound (6) where t is 7 is effective in maintaining a large voltage holding ratio at room temperature and also at the temperature close to the maximum temperature even after the device has been used for a long period of time because such compound (6) has a small volatility. A preferred proportion of the antioxidant is about 50 ppm or more for achieving an effect thereof, and about 600 ppm or less for avoiding a decrease in the maximum temperature or avoiding an increase in the minimum temperature. A further preferred proportion is in the range of about 100 ppm to about 300 ppm.

Preferred examples of the ultraviolet light absorber include a benzophenone derivative, a benzoate derivative and a triazole derivative. A light stabilizer such as an amine having steric hindrance is also preferred. A preferred proportion of the absorber or the stabilizer is about 50 ppm or more for achieving an effect thereof, and about 10,000 ppm or less for avoiding the decrease in the maximum temperature or avoiding the increase in the minimum temperature. A further preferred proportion is in the range of about 100 ppm to about 10,000 ppm.

A dichroic dye such as an azo dye and an anthraquinone dye is added to the composition to be adapted for a device having a guest host (GH) mode. A preferred proportion of the dye is in the range of about 0.01% by weight to about 10% by weight. The antifoaming agent such as dimethyl silicone oil or methyl phenyl silicone oil is added to the composition for preventing foam formation. A preferred proportion of the antifoaming agent is about 1 ppm or more for achieving an effect thereof, and about 1000 ppm or less for preventing a poor display. A further preferred proportion is in the range of about 1 ppm to about 500 ppm.

The polymerizable compound is added to the composition to be adapted for a polymer sustained alignment (PSA) mode device. Specific preferred of polymerizable compounds include a compound having a polymerizable group such as acrylate, methacrylate, a vinyl compound, a vinyloxy compound, propenyl ether, an epoxy compound (oxirane, oxetane) and vinyl ketone. Further preferred examples include an acrylate derivative or a methacrylate derivative. A preferred proportion of the polymerizable compound is about 0.05% by weight or more for achieving the effect thereof, and about 10% by weight or less for preventing a poor display. A further preferred proportion is in the range of about 0.1% by weight to about 2% by weight. The polymerizable compound is polymerized by irradiation with ultraviolet irradiation. The polymerizable compound may be polymerized in the presence of an initiator such as a photopolymerization initiator. Suitable conditions for polymerization, suitable types of the initiator and suitable amounts thereof are known to those skilled in the art and are described in literature. For example, Irgacure 651 (registered trademark; BASF), Irgacure 184 (registered trademark; BASF) or Darocure 1173 (registered trademark; BASF), each being a photoinitiator, is suitable for radical polymerization. A preferred proportion of the photopolymerization initiator is in the range of about 0.1 part by weight to about 5 parts by weight based on 100 parts by weight in the weight of the polymerizable compound. A further preferred proportion is in the range of about 1 part by weight to about 3 parts by weight.

Upon storing the polymerizable compound, the polymerization inhibitor may be added thereto for preventing polymerization. The polymerizable compound is ordinarily added to the composition without removing the polymerization inhibitor. Examples of the polymerization inhibitor include hydroquinone, a hydroquinone derivative such as methylhydroquinone, 4-t-butylcatechol, 4-methoxyphenol and phenothiazine.

Last, the application of the composition will be described. The composition of the invention mainly has a minimum temperature of about −10° C. or lower, a maximum temperature of about 70° C. or higher, and an optical anisotropy in the range of about 0.20 to about 0.35. A device including the composition has the large voltage holding ratio. The composition is suitable for use in the AM device. The composition is particularly suitable for use in a transmissive AM device. The composition having an optical anisotropy in the range of about 0.15 to about 0.20 and further the composition having an optical anisotropy in the range of about 0.35 to about 0.40 may be prepared by controlling the proportion of the component compounds or by mixing any other liquid crystal compound. The composition can be used as the composition having the nematic phase, and as the optically active composition by adding the optically active compound.

The composition can be used for the AM device. The composition can also be used for a PM device. The composition can also be used for the AM device and the PM device each having a mode such as the PC mode, the TN mode, the STN mode, the ECB mode, the OCB mode, the IPS mode, the FFS mode, the VA mode and the FPA mode. Use for the AM device having the TN mode, the OCB mode, the IPS mode or the FFS mode is particularly preferred. In the AM device having the IPS mode or the FFS mode, alignment of liquid crystal molecules when no voltage is applied may be parallel or vertical to a glass substrate. The devices may be of a reflective type, a transmissive type or a transflective type. Use for the transmissive device is preferred. The composition can also be used for an amorphous silicon-TFT device or a polycrystal silicon-TFT device. The composition can also be used for a nematic curvilinear aligned phase (NCAP) device prepared by microencapsulating the composition, or for a polymer dispersed (PD) device in which a three-dimensional network-polymer is formed in the composition.

### EXAMPLES

The invention will be described in greater detail by way of Examples. The invention is not limited by the Examples. The invention also includes a mixture in which at least two compositions in Examples were mixed. The synthesized compound was identified by methods such as an NMR analysis. Characteristics of the compound and the composition were measured by methods described below.

NMR analysis: For measurement, DRX-500 made by Bruker BioSpin Corporation was used. In ¹H-NMR measurement, a sample was dissolved in a deuterated solvent such as CDCl₃, and measurement was carried out under conditions of room temperature, 500 MHz and 16 times of accumulation. Tetramethylsilane was used as an internal standard. In ¹⁹F-NMR measurement, measurement was carried out under conditions of 24 times of accumulation using CFCl₃ as an internal standard. In explaining nuclear magnetic resonance spectra obtained, s, d, t, q, quin, sex and m stand for a singlet, a doublet, a triplet, a quartet, a quintet, a sextet and a multiplet, and br being broad, respectively.

Gas chromatographic analysis: For measurement, GC-14B Gas Chromatograph made by Shimadzu Corporation was used. A carrier gas was helium (2 mL per minute). A sample vaporizing chamber and a detector (FID) were set to 280° C. and 300° C., respectively. A capillary column DB-1 (length 30 m, bore 0.32 mm, film thickness 0.25 μm; dimethylpolysiloxane as a stationary phase; non-polar) made by Agilent Technologies, Inc. was used for separation of component compounds. After the column was kept at 200° C. for 2 minutes, the column was heated to 280° C. at a ratio of 5° C. per minute. A sample was prepared in an acetone solution (0.1% by weight), and then 1 microliter of the solution was injected into the sample vaporizing chamber. A recorder was C-R5A Chromatopac made by Shimadzu Corporation or the equivalent thereof. The resulting gas chromatogram showed a retention time of a peak and a peak area corresponding to each of the component compounds.

As a solvent for diluting the sample, chloroform, hexane or the like may also be used. The following capillary columns may also be used for separating component compounds: HP-1 (length 30 m, bore 0.32 mm, film thickness 0.25 μm) made by Agilent Technologies, Inc., Rtx-1 (length 30 m, bore 0.32 mm, film thickness 0.25 μm) made by Restek Corporation and BP-1 (length 30 m, bore 0.32 mm, film thickness 0.25 μm) made by SGE International Pty. Ltd. A capillary column CBP1-M50-025 (length 50 m, bore 0.25 mm, film thickness 0.25 μm) made by Shimadzu Corporation may also be used for the purpose of preventing an overlap of peaks of the compounds.

A proportion of liquid crystal compounds contained in the composition may be calculated by the method as described below. The mixture of liquid crystal compounds is detected by gas chromatograph (FID). An area ratio of each peak in the gas chromatogram corresponds to the ratio (weight ratio) of the liquid crystal compounds. When the capillary columns described above were used, a correction coefficient of each of the liquid crystal compounds may be regarded as 1 (one). Accordingly, the proportion (% by weight) of the liquid crystal compounds can be calculated from the area ratio of each peak.

Sample for measurement: When characteristics of a composition were measured, the composition was used as a sample as was. Upon measuring characteristics of a compound, a sample for measurement was prepared by mixing the compound (15% by weight) with a base liquid crystal (85% by weight). Values of characteristics of the compound were calculated, according to an extrapolation method, using values obtained by measurement. (Extrapolated value)={(measured value of a sample)−0.85× (measured value of a base liquid crystal)}/0.15. When a smectic phase (or crystals) precipitated at the proportion thereof at 25° C., a ratio of the compound to the base liquid crystal was changed step by step in the order of (10% by weight: 90% by weight), (5% by weight: 95% by weight) and (1% by weight: 99% by weight). Values of maximum temperature, optical anisotropy, viscosity and dielectric anisotropy with regard to the compound were determined according to the extrapolation method.

A base liquid crystal described below was used. A proportion of the component compound was expressed in terms of weight percent (% by weight).

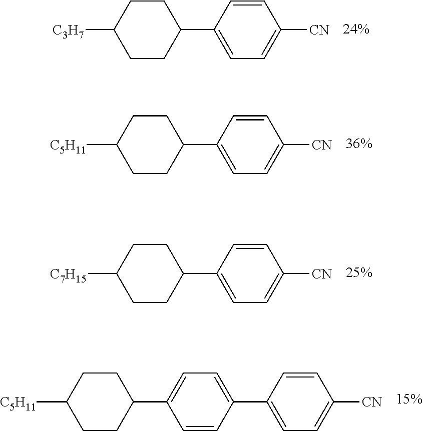

Measuring method: Characteristics were measured according to the methods described below. Most of the measuring methods are applied as described in the Standard of Japan Electronics and Information Technology Industries Association (hereinafter abbreviated as JEITA) (JEITA ED-2521B) discussed and established by JEITA, or modified thereon. No thin film transistor (TFT) was attached to a TN device used for measurement.

(1) Maximum temperature of nematic phase (NI; ° C.): A sample was placed on a hot plate in a melting point measuring apparatus equipped with a polarizing microscope, and heated at a rate of 1° C. per minute. Temperature when part of the sample began to change from a nematic phase to an isotropic liquid was measured.

(2) Minimum temperature of nematic phase (Ta; ° C.): Samples each having a nematic phase were put in glass vials and kept in freezers at temperatures of 0° C., −10° C., −20° C., −30° C. and −40° C. for 10 days, and then liquid crystal phases were observed. For example, when the sample maintained the nematic phase at −20° C. and changed to crystals or a smectic phase at −30° C., Tc was expressed as T_{c}<−20° C.

(3) Viscosity (bulk viscosity; η; measured at 20° C.; mPa·s): For measurement, a cone-plate (E type) rotational viscometer made by Tokyo Keiki Inc. was used.

(4) Viscosity (rotational viscosity; γ1; measured at 20° C.; mPa·s): Measurement was carried out according to the method described in M. Imai et al., Molecular Crystals and Liquid Crystals, Vol. 259, 37 (1995). A sample was put in a TN device in which a twist angle was 0 degrees and a distance (cell gap) between two glass substrates was 5 micrometers. Voltage was applied stepwise to the device in the range of 16 V to 19.5 V at an increment of 0.5 V. After a period of 0.2 second with no voltage application, voltage was repeatedly applied under conditions of only one rectangular wave (rectangular pulse; 0.2 second) and no voltage application (2 seconds). A peak current and a peak time of a transient current generated by the applied voltage were measured. A value of rotational viscosity was obtained from the measured values and calculation equation (8) described on page 40 of the paper presented by M. Imai et al. A value of dielectric anisotropy required for the calculation was determined using the device by which the rotational viscosity was measured and by the method described below.

(5) Optical anisotropy (refractive index anisotropy; Δn; measured at 25° C.): Measurement was carried out by an Abbe refractometer with a polarizing plate mounted on an ocular, using light at a wavelength of 589 nanometers. A surface of a main prism was rubbed in one direction, and then a sample was added dropwise onto the main prism. A refractive index (n∥) was measured when a direction of polarized light was parallel to a direction of rubbing. A refractive index (n⊥) was measured when the direction of polarized light was perpendicular to a direction of rubbing. A value of optical anisotropy was calculated from an equation: Δn=n∥−n⊥. In a mode in which optical change by a Kerr effect is utilized, a product of the optical anisotropy and dielectric anisotropy is preferably larger, and therefore the optical anisotropy is preferably as larger as possible. The optical anisotropy is preferably in the range of 0.20 to 0.35, and further preferably in the range of 0.23 to 0.32.

(6) Dielectric anisotropy (Δ∈; measured at 25° C.): A sample was put in a TN device in which a distance (cell gap) between two glass substrates was 9 micrometers and a twist angle was 80 degrees. Sine waves (10 V, 1 kHz) were applied to the device, and after 2 seconds, a dielectric constant (∈∥) in a major axis direction of the liquid crystal molecules was measured. Sine waves (0.5 V, 1 kHz) were applied to the device, and after 2 seconds, a dielectric constant (∈⊥) in a minor axis direction of the liquid crystal molecules was measured. A value of dielectric anisotropy was calculated from an equation: Δ∈=∈∥−∈⊥. The dielectric anisotropy is preferably larger for decreasing drive voltage. In particular, in a mode in which an electric field that applies to a liquid crystal composition is limited due to polymer stabilization, encapsulation or the like, the drive voltage tends to become high, and therefore the dielectric anisotropy is preferably as larger as possible. Moreover, in the mode in which the optical change by the Kerr effect is utilized, the product of the optical anisotropy and the dielectric anisotropy is preferably larger, and therefore the dielectric anisotropy is preferably as larger as possible. The dielectric anisotropy is preferably in the range of 8 to 40, and further preferably in the range of 15 to 30.

(7) Threshold voltage (Vth; measured at 25° C.; V): For measurement, an LCD5100 luminance meter made by Otsuka Electronics Co., Ltd. was used. A light source was a halogen lamp. A sample was put in a normally white mode TN device in which a distance (cell gap) between two glass substrates was 0.45/Δn (μm) and a twist angle was 80 degrees. A voltage (32 Hz, rectangular waves) to be applied to the device was stepwise increased from 0 V to 10 V at an increment of 0.02 V. On the occasion, the device was irradiated with light from a direction perpendicular to the device, and an amount of light transmitted through the device was measured. A voltage-transmittance curve was prepared, in which the maximum amount of light corresponds to 100% transmittance and the minimum amount of light corresponds to 0% transmittance. A threshold voltage is expressed in terms of a voltage at 90% transmittance.

(8) Voltage holding ratio (VHR-1; measured at 25° C.; %): A TN device used for measurement had a polyimide alignment film, and a distance (cell gap) between two glass substrates was 5 micrometers. A sample was put in the device, and then the device was sealed with an ultraviolet-curable adhesive. A pulse voltage (60 microseconds at 5 V) was applied to the TN device and the device was charged. A decaying voltage was measured for 16.7 milliseconds with a high-speed voltmeter, and area A between a voltage curve and a horizontal axis in a unit cycle was determined. Area B is an area without decay. A voltage holding ratio is expressed in terms of a percentage of area A to area B.

(9) Voltage holding ratio (VHR-2; measured at 80° C.; %): A voltage holding ratio was measured according to procedures identical with the procedures described above except that measurement was carried out at 80° C. in place of 25° C. The thus obtained value was expressed in terms of VHR-2.

(10) Voltage holding ratio (VHR-3; measured at 25° C.; %): Stability to ultraviolet light was evaluated by measuring a voltage holding ratio after a device was irradiated with ultraviolet light. A TN device used for measurement had a polyimide alignment film, and a cell gap was 5 micrometers. A sample was injected into the device, and then the device was irradiated with light for 20 minutes. A light source was an ultra high-pressure mercury lamp USH-500D (made by Ushio, Inc.), and a distance between the device and the light source was 20 centimeters. In measurement of VHR-3, a decaying voltage was measured for 16.7 milliseconds. A composition having large VHR-3 has a large stability to ultraviolet light. A value of VHR-3 is preferably 90% or more, and further preferably, 95% or more.

(11) Voltage holding ratio (VHR-4; measured at 25° C.; %): Stability to heat was evaluated by measuring a voltage holding ratio after a TN device into which a sample was injected was heated in a constant-temperature bath at 80° C. for 500 hours. In measurement of VHR-4, a decaying voltage was measured for 16.7 milliseconds. A composition having large VHR-4 has a large stability to heat.

(12) Response time (T; measured at 25° C.; ms): For measurement, an LCD5100 luminance meter made by Otsuka Electronics Co., Ltd. was used. A light source was a halogen lamp. A low-pass filter was set to 5 kHz. A sample was put in a normally white mode TN device in which a distance (cell gap) between two glass substrates was 5.0 micrometers and a twist angle was 80 degrees. A voltage (rectangular waves; 60 Hz, 5 V, 0.5 second) was applied to the device. On the occasion, the device was irradiated with light from a direction perpendicular to the device, and an amount of light transmitted through the device was measured. The maximum amount of light corresponds to 100% transmittance, and the minimum amount of light corresponds to 0% transmittance. A rise time (τr; millisecond) was expressed in terms of time required for a change from 90% transmittance to 10% transmittance. A fall time (τf; millisecond) was expressed in terms of time required for a change from 10% transmittance to 90% transmittance. A response time was represented by a sum of the rise time and the fall time thus obtained.

(13) Elastic constant (K; measured at 25° C.; pN): For measurement, HP4284A LCR Meter made by Yokogawa-Hewlett-Packard Co. was used. A sample was put in a horizontal alignment device in which a distance (cell gap) between two glass substrates was 20 micrometers. An electric charge of 0 V to 20 V was applied to the device, and electrostatic capacity and applied voltage were measured. The measured values of electrostatic capacity (C) and applied voltage (V) were fitted to equation (2.98) and equation (2.101) on page 75 of “Liquid Crystal Device Handbook” (Ekisho Debaisu Handobukku, in Japanese; The Nikkan Kogyo Shimbun, Ltd.), and values of K11 and K33 were obtained from equation (2.99). Next, K22 was calculated using the previously determined values of K11 and K33 in equation (3.18) on page 171. Elastic constant K was expressed in terms of a mean value of the thus determined K11, K22 and K33.

(14) Specific resistance (ρ; measured at 25° C.; Ωcm): Into a vessel equipped with electrodes, 1.0 milliliter of sample was injected. A direct current voltage (10 V) was applied to the vessel, and a direct current after 10 seconds was measured. Specific resistance was calculated from the following equation: (specific resistance)={(voltage)× (electric capacity of a vessel)}/{(direct current)× (dielectric constant of vacuum)}.

(15) Helical pitch (P; measured at room temperature; μm): A helical pitch was measured according to a wedge method. Refer to page 196 in “Handbook of Liquid Crystals (Ekisho Binran in Japanese)” (issued in 2000, Maruzen Co., Ltd.). A sample was injected into a wedge cell and left to stand at room temperature for 2 hours, and then a gap (d2−d1) between disclination lines was observed by a polarizing microscope (trade name: MM40/60 Series, Nikon Corporation). A helical pitch (P) was calculated according to the following equation in which an angle of the wedge cell was expressed as θ: P=2× (d2−d1)× tan δ.

(16) Dielectric constant (∈⊥; measured at 25° C.) in a minor axis direction: A sample was put in a TN device in which a distance (cell gap) between two glass substrates was 9 micrometers and a twist angle was 80 degrees. Sine waves (0.5 V, 1 kHz) were applied to the device, and after 2 seconds, a dielectric constant (∈⊥) in a minor axis direction of the liquid crystal molecules was measured.

The compounds in Examples were represented using symbols according to definitions in Table 3 described below. In Table 3, the configuration of 1,4-cyclohexylene is trans. A parenthesized number next to a symbolized compound corresponds to the number of the compound. A symbol (-) means any other liquid crystal compound. A proportion (percentage) of the liquid crystal compound is expressed in terms of weight percent (% by weight) based on the weight of the liquid crystal composition. Values of the characteristics of the composition were summarized in a last part.

TABLE 3
Method for Description of Compounds using Symbols
R—(A₁)—Z₁— . . . —Zₙ—(Aₙ)—R′

| 1) Left-terminal Group R— | Symbol |
|---|---|
| CₙH₂ₙ₊₁— | n- |
| CₙH₂ₙ₊₁O— | nO— |
| CₘH₂ₘ₊₁OCₙH₂ₙ— | mOn— |
| CH₂═CH— | V— |
| CₙH₂ₙ₊₁—CH═CH— | nV— |
| CH₂═CH—CₙH₂ₙ— | Vn— |
| CₘH₂ₘ₊₁—CH═CH—CₙH₂ₙ— | mVn— |
| CF₂═CH— | VFF— |
| CF₂═CH—CₙH₂ₙ— | VFFn— |
| 2) Right-terminal Group —R′ | Symbol |
| —CₙH₂ₙ₊₁ | -n |
| —OCₙH₂ₙ₊₁ | —On |
| —CH═CH₂ | —V |
| —CH═CH—CₙH₂ₙ₊₁ | —Vn |
| —CₙH₂ₙ—CH═CH₂ | —nV |
| —CₙH₂ₙ—CH═CH—CₘH₂ₘ₊₁ | —nVm |
| —CH═CF₂ | —VFF |
| —COOCH₃ | —EMe |
| —F | —F |
| —Cl | —CL |
| —OCF₃ | —OCF3 |
| —CF₃ | —CF3 |
| —CN | —C |
| —OCH═CH—CF₂H | —OVCF2H |
| —OCH═CH—CF₃ | —OVCF3 |
| 3) Bonding Group —Zₙ— | Symbol |
| —C₂H₄— | 2 |
| —COO— | E |
| —CH═CH— | V |
| —C≡C— | T |
| —CF₂O— | X |
| —CH₂O— | 1O |
| 4) Ring Structure —Aₙ— | Symbol |
| 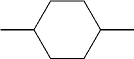 | H |
| 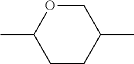 | Dh |
| 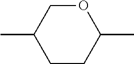 | dh |
| 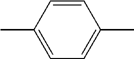 | B |
| 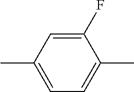 | B(F) |
| 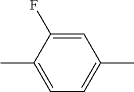 | B(2F) |
| 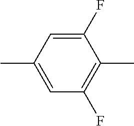 | B(F,F) |
| 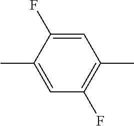 | B(2F,5F) |
| 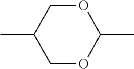 | G |
| 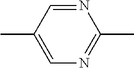 | Py |

5) Examples of Description
Example 1. 3-BB(F)TB-2

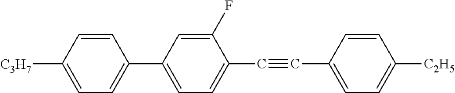

Example 2. 3-BB(F)B(F,F)—F

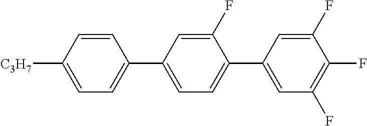

Example 3. 4-BB(F)B(F,F)XB(F,F)—F

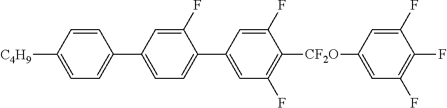

### Example 1

| | | |
|---|---|---|
| 3-HB(F)TB-2 | (1-1-3) | 5% |
| 3-HB(F)TB-3 | (1-1-3) | 5% |
| 3-HB(F)TB-4 | (1-1-3) | 5% |
| 3-H2BTB-2 | (1-1-5) | 3% |
| 3-H2BTB-3 | (1-1-5) | 3% |
| 3-H2BTB-4 | (1-1-5) | 3% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 3-BB(F)B(F,F)-F | (2-2-4) | 3% |
| 2-BTB-O1 | (3-3) | 7.8% |
| 3-BTB-O1 | (3-3) | 7.8% |
| 4-BTB-O1 | (3-3) | 7.8% |
| 4-BTB-O2 | (3-3) | 7.8% |
| 5-BTB-O1 | (3-3) | 7.8% |

NI=90.0° C.; Tc<−20° C.; Δn=0.246; Δ∈=9.4; Vth=1.88 V; η=42.7 mPa·s; γ1=279 mPa·s; VHR-1=98.7%; VHR-3=97.0%.

### Comparative Example 1

The composition in Example 1 contains compound (2) being the second component. Compound (2) has a positive dielectric anisotropy. For comparison, a composition in which all of compounds (2) in Example 1 were removed, and a compound having a positive dielectric anisotropy and a cyano group was added was taken as Comparative Example 1.

| | | |
|---|---|---|
| 3-HB(F)TB-2 | (1-1-3) | 7% |
| 3-HB(F)TB-3 | (1-1-3) | 7% |
| 3-HB(F)TB-4 | (1-1-3) | 7% |
| 3-H2BTB-2 | (1-1-5) | 5% |
| 3-H2BTB-3 | (1-1-5) | 4% |
| 3-H2BTB-4 | (1-1-5) | 4% |
| 2-BTB-O1 | (3-3) | 8.6% |
| 3-BTB-O1 | (3-3) | 8.6% |
| 4-BTB-O1 | (3-3) | 8.6% |
| 4-BTB-O2 | (3-3) | 8.6% |
| 5-BTB-O1 | (3-3) | 8.6% |
| 1V2-BEB(F,F)-C | | 11% |
| 2-BEB(F)-C | | 3% |
| 3-BEB(F)-C | | 3% |
| 2-HHB-C | | 3% |
| 3-HHB-C | | 3% |

NI=93.7° C.; Tc<−20° C.; Δn=0.242; Δ∈=10.0; Vth=1.82 V; η=32.3 mPa·s; γ1=264 mPa·s; VHR-1=97.5%; VHR-3=10.6%.

VHR of the compound having the cyano group is significantly decreased after irradiated with ultraviolet light, and therefore the compound is found to be unsuitable as a liquid crystal composition of the invention.

### Comparative Example 2

For comparison, a composition in which part of compound (2) in Example 1 was used in place of a compound having a positive dielectric anisotropy and a cyano group was taken as Comparative Example 2.

| | | |
|---|---|---|
| 3-HB(F)TB-2 | (1-1-3) | 7% |
| 3-HB(F)TB-3 | (1-1-3) | 7% |
| 3-HB(F)TB-4 | (1-1-3) | 7% |
| 3-H2BTB-2 | (1-1-5) | 5% |
| 3-H2BTB-3 | (1-1-5) | 4% |
| 3-H2BTB-4 | (1-1-5) | 4% |
| 4-BB(F)B(F,F)XB(F,F)-F | (2-1-6) | 7% |
| 5-BB(F)B(F,F)XB(F,F)-F | (2-1-6) | 6% |
| 2-BTB-O1 | (3-3) | 8.6% |
| 3-BTB-O1 | (3-3) | 8.6% |
| 4-BTB-O1 | (3-3) | 8.6% |
| 4-BTB-O2 | (3-3) | 8.6% |
| 5-BTB-O1 | (3-3) | 8.6% |
| 1V2-BEB(F,F)-C | (—) | 10% |

NI=95.7° C.; Tc<−20° C.; Δn=0.253; Δ∈=9.2; Vth=1.93 V; η=35.5 mPa·s; VHR-1=96.6%; VHR-3=42.4%.

VHR of the compound having the cyano group is significantly decreased after irradiated with ultraviolet light, and therefore the compound is found to be unsuitable as a liquid crystal composition of the invention.

### Comparative Example 3

For comparison, a composition in which part of compound (2) in Example 1 was used in place of a compound having a positive dielectric anisotropy and a cyano group was taken as Comparative Example 3.

| | | |
|---|---|---|
| 3-HB(F)TB-2 | (1-1-3) | 7% |
| 3-HB(F)TB-3 | (1-1-3) | 7% |
| 3-HB(F)TB-4 | (1-1-3) | 6% |
| 3-H2BTB-2 | (1-1-5) | 3% |
| 3-H2BTB-3 | (1-1-5) | 3% |
| 3-H2BTB-4 | (1-1-5) | 3% |
| 3-BB(F)B(F,F)XB(F,F)-F | (2-1-6) | 2% |
| 4-BB(F)B(F,F)XB(F,F)-F | (2-1-6) | 8% |
| 5-BB(F)B(F,F)XB(F,F)-F | (2-1-6) | 8% |
| 3-BB(F,F)XB(F)B(F,F)-F | (2-1-10) | 5% |
| 2-BTB-O1 | (3-3) | 8.6% |
| 3-BTB-O1 | (3-3) | 8.6% |
| 4-BTB-O1 | (3-3) | 8.6% |
| 4-BTB-O2 | (3-3) | 8.6% |
| 5-BTB-O1 | (3-3) | 8.6% |
| 1V2-BEB(F,F)-C | (—) | 5% |

NI=97.0° C.; Tc<−20° C.; Δn=0.254; Δ∈=9.2; Vth=1.94 V; η=38.5 mPa·s; VHR-1=96.8%; VHR-3=72.2%.

VHR of the compound having the cyano group is decreased after irradiated with ultraviolet light, and therefore the compound is found to be unsuitable as a liquid crystal composition of the invention.

### Comparative Example 4

For comparison, a composition in which part of compound (2) in Example 1 was used in place of a compound having a positive dielectric anisotropy and a cyano group was taken as Comparative Example 4.

| | | |
|---|---|---|
| 3-HB(F)TB-2 | (1-1-3) | 7% |
| 3-HB(F)TB-3 | (1-1-3) | 7% |
| 3-HB(F)TB-4 | (1-1-3) | 7% |
| 3-H2BTB-2 | (1-1-5) | 5% |
| 3-BB(F)B(F,F)XB(F,F)-F | (2-1-6) | 2% |
| 4-BB(F)B(F,F)XB(F,F)-F | (2-1-6) | 8% |
| 5-BB(F)B(F,F)XB(F,F)-F | (2-1-6) | 8% |
| 3-BB(F,F)XB(F)B(F,F)-F | (2-1-10) | 7% |
| 3-BB(F)B(F,F)-F | (2-2-4) | 3% |
| 2-BTB-O1 | (3-3) | 8.6% |
| 3-BTB-O1 | (3-3) | 8.6% |
| 4-BTB-O1 | (3-3) | 8.6% |
| 4-BTB-O2 | (3-3) | 8.6% |
| 5-BTB-O1 | (3-3) | 8.6% |
| 1V2-BEB(F,F)-C | (—) | 3% |

NI=95.2° C.; Tc<−20° C.; Δn=0.254; Δ∈=9.1; Vth=1.90 V; η=39.4 mPa·s; VHR-1=97.2%; VHR-3=81.6%.

VHR of the compound having the cyano group is decreased after irradiated with ultraviolet light, and therefore the compound is found to be unsuitable as a liquid crystal composition of the invention.

### Example 2

| | | |
|---|---|---|
| 2-BTB(F)TB-5 | (1-1-11) | 5% |
| 3-BTB(F)TB-5 | (1-1-11) | 5% |
| 4-BTB(F)TB-5 | (1-1-11) | 5% |
| 5-BTB(F)TB-2 | (1-1-11) | 5% |
| 3-BB(F,F)XB(F,F)-F | (2-1-2) | 2% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 9% |
| 5-BB(F)B(F,F)XB(F,F)-F | (2-1-6) | 9% |
| 3-BB(F,F)XB(F)B(F,F)-F | (2-1-10) | 5% |
| 3-BB(F)B(F,F)-F | (2-2-4) | 8% |
| 2-BTB-O1 | (3-3) | 7.8% |
| 3-BTB-O1 | (3-3) | 7.8% |
| 4-BTB-O1 | (3-3) | 7.8% |
| 4-BTB-O2 | (3-3) | 7.8% |
| 5-BTB-O1 | (3-3) | 7.8% |
| 5-HBB(F)B-2 | (3-12) | 3% |

NI=102.1° C.; Tc<−10° C.; Δn=0.295; Δ∈=10.3; Vth=1.98 V; η=58.2 mPa·s; γ1=385 mPa·s.

### Example 3

| | | |
|---|---|---|
| 3-HB(F)TB-2 | (1-1-3) | 5% |
| 3-HB(F)TB-3 | (1-1-3) | 5% |
| 3-HB(F)TB-4 | (1-1-3) | 4% |
| 2-BTB(F)TB-5 | (1-1-11) | 6% |
| 3-BTB(F)TB-5 | (1-1-11) | 6% |
| 4-BTB(F)TB-5 | (1-1-11) | 5% |
| 5-BTB(F)TB-2 | (1-1-11) | 5% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 9% |
| 5-BB(F)B(F,F)XB(F,F)-F | (2-1-6) | 9% |
| 3-BB(F,F)XB(F)B(F,F)-F | (2-1-10) | 7% |
| 3-BB(F)B(F,F)-F | (2-2-4) | 8% |
| 1-BTB-3 | (3-3) | 15% |
| 2-BTB-1 | (3-3) | 11% |

NI=104.2° C.; Tc<−10° C.; Δn=0.290; Δ∈=10.0; Vth=2.00 V; η=37.1 mPa·s; γ1=337 mPa·s.

### Example 4

| | | |
|---|---|---|
| 3-HB(F)TB-2 | (1-1-3) | 5% |
| 3-HB(F)TB-3 | (1-1-3) | 5% |
| 3-H2BTB-2 | (1-1-5) | 4% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 5-BB(F)B(F)B(F,F)XB(F,F)-F | (2-1-12) | 10% |
| 3-BB(F)B(F,F)-F | (2-2-4) | 3% |
| 2-BTB-O1 | (3-3) | 7.8% |
| 3-BTB-O1 | (3-3) | 7.8% |
| 4-BTB-O1 | (3-3) | 7.8% |
| 4-BTB-O2 | (3-3) | 7.8% |
| 5-BTB-O1 | (3-3) | 7.8% |

NI=92.5° C.; Tc<−10° C.; Δn=0.251; Δ∈=14.7; Vth=1.58 V.

### Example 5

| | | |
|---|---|---|
| 3-HB(F)TB-2 | (1-1-3) | 5% |
| 3-HB(F)TB-3 | (1-1-3) | 5% |
| 3-H2BTB-2 | (1-1-5) | 4% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 3-BB(F)B(F,F)-F | (2-2-4) | 3% |
| 4-B(F)BB(F)2B(F)B(F,F)-F | (2-2-12) | 10% |
| 2-BTB-O1 | (3-3) | 7.8% |
| 3-BTB-O1 | (3-3) | 7.8% |
| 4-BTB-O1 | (3-3) | 7.8% |
| 4-BTB-O2 | (3-3) | 7.8% |
| 5-BTB-O1 | (3-3) | 7.8% |

NI=93.8° C.; Tc<−20° C.; Δn=0.252; Δ∈=12.9; Vth=1.66 V.

### Example 6

| | | |
|---|---|---|
| 3-HB(F)TB-2 | (1-1-3) | 5% |
| 3-HB(F)TB-3 | (1-1-3) | 5% |
| 3-H2BTB-2 | (1-1-5) | 3% |
| 3-H2BTB-3 | (1-1-5) | 3% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 5-BB(F)B(F,F)XB(F)B(F,F)-F | (2-1-11) | 10% |
| 3-BB(F)B(F,F)-F | (2-2-4) | 3% |
| 2-BTB-O1 | (3-3) | 7.4% |
| 3-BTB-O1 | (3-3) | 7.4% |
| 4-BTB-O1 | (3-3) | 7.4% |
| 4-BTB-O2 | (3-3) | 7.4% |
| 5-BTB-O1 | (3-3) | 7.4% |

NI=93.0° C.; Tc<−20° C.; Δn=0.248; Δ∈=14.0; Vth=1.64 V.

### Example 7

| | | |
|---|---|---|
| 3-HB(F)TB-2 | (1-1-3) | 5% |
| 3-HB(F)TB-3 | (1-1-3) | 5% |
| 3-HB(F)TB-4 | (1-1-3) | 5% |
| 3-H2BTB-2 | (1-1-5) | 3% |
| 3-H2BTB-3 | (1-1-5) | 3% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 4-BB(F)B(F,F)XB(F,F)-CF3 | (2-1-13) | 10% |
| 3-BB(F)B(F,F)-F | (2-2-4) | 3% |
| 2-BTB-O1 | (3-3) | 6.4% |
| 3-BTB-O1 | (3-3) | 6.4% |
| 4-BTB-O1 | (3-3) | 6.4% |
| 4-BTB-O2 | (3-3) | 6.4% |
| 5-BTB-O1 | (3-3) | 6.4% |

NI=91.9° C.; Tc<−10° C.; Δn=0.245; Δ∈=17.4; Vth=2.11 V.

### Example 8

| | | |
|---|---|---|
| 3-HB(F)TB-2 | (1-1-3) | 5% |
| 3-HB(F)TB-3 | (1-1-3) | 5% |
| 3-HB(F)TB-4 | (1-1-3) | 5% |
| 3-H2BTB-2 | (1-1-5) | 4% |
| 3-H2BTB-3 | (1-1-5) | 3% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 3-BB(F)B(F,F)-F | (2-2-4) | 3% |
| 3-BB(F)B(F,F)VCF3 | (2-2-6) | 5% |
| 2-BTB-O1 | (3-3) | 7.2% |
| 3-BTB-O1 | (3-3) | 7.2% |
| 4-BTB-O1 | (3-3) | 7.2% |
| 4-BTB-O2 | (3-3) | 7.2% |
| 5-BTB-O1 | (3-3) | 7.2% |

NI=91.5° C.; Tc<−10° C.; Δn=0.249; Δ∈=11.7; Vth=1.75 V.

### Example 9

| | | |
|---|---|---|
| 3-HB(F)TB-2 | (1-1-3) | 8% |
| 3-HB(F)TB-3 | (1-1-3) | 8% |
| 3-HB(F)TB-4 | (1-1-3) | 8% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 10% |
| 3-BB(F)B(F,F)-CF3 | (2-2-5) | 5% |
| 2-BTB-O1 | (3-3) | 6.6% |
| 3-BTB-O1 | (3-3) | 6.6% |
| 4-BTB-O1 | (3-3) | 6.6% |
| 4-BTB-O2 | (3-3) | 6.6% |
| 5-BTB-O1 | (3-3) | 6.6% |

NI=92.2° C.; Tc<−20° C.; Δn=0.244; Δ∈=12.3; Vth=1.65 V.

### Example 10

| | | |
|---|---|---|
| 3-HB(F)TB-2 | (1-1-3) | 5% |
| 3-HB(F)TB-3 | (1-1-3) | 5% |
| 3-HB(F)TB-4 | (1-1-3) | 2% |
| 3-H2BTB-2 | (1-1-5) | 3% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 3-BB(F)B(F,F)-F | (2-2-4) | 3% |
| 3-GB(F)B(F)B(F)-F | (2-2-11) | 10% |
| 2-BTB-O1 | (3-3) | 7.6% |
| 3-BTB-O1 | (3-3) | 7.6% |
| 4-BTB-O1 | (3-3) | 7.6% |
| 4-BTB-O2 | (3-3) | 7.6% |
| 5-BTB-O1 | (3-3) | 7.6% |

NI=93.0° C.; Tc<−20° C.; Δn=0.246; Δ∈=13.2; Vth=1.58 V.

### Example 11

| | | |
|---|---|---|
| 3-HB(F)TB-2 | (1-1-3) | 6% |
| 3-HB(F)TB-3 | (1-1-3) | 4% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 9% |
| 5-BB(F)B(F,F)XB(F,F)-F | (2-1-6) | 9% |
| 3-BB(F,F)XB(F)B(F,F)-F | (2-1-10) | 12% |
| 5-BB(F)B(F,F)XB(F)B(F,F)-F | (2-1-11) | 10% |
| 4-BB(F)B(F,F)XB(F,F)-CF3 | (2-1-13) | 5% |
| 3-BB(F)B(F,F)-CF3 | (2-2-5) | 7% |
| 2-BTB-O1 | (3-3) | 6.6% |
| 3-BTB-O1 | (3-3) | 6.6% |
| 4-BTB-O1 | (3-3) | 6.6% |
| 4-BTB-O2 | (3-3) | 6.6% |
| 5-BTB-O1 | (3-3) | 6.6% |

NI=98.4° C.; Tc<−10° C.; Δn=0.256; Δ∈=24.0; Vth=1.66 V.

### Example 12

| | | |
|---|---|---|
| 3-HB(F)TB-2 | (1-1-3) | 7% |
| 3-HB(F)TB-3 | (1-1-3) | 7% |
| 3-HB(F)TB-4 | (1-1-3) | 6% |
| 3-H2BTB-2 | (1-1-5) | 4% |
| 3-B2B(F)TB-2 | (1-1-8) | 10% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 3-BB(F)B(F,F)-F | (2-2-4) | 3% |
| 2-BTB-O1 | (3-3) | 5.8% |
| 3-BTB-O1 | (3-3) | 5.8% |
| 4-BTB-O1 | (3-3) | 5.8% |
| 4-BTB-O2 | (3-3) | 5.8% |
| 5-BTB-O1 | (3-3) | 5.8% |

NI=94.9° C.; Tc<−20° C.; Δn=0.247; Δ∈=9.7; Vth=1.91 V.

### Example 13

| | | |
|---|---|---|
| 3-HB(F)TB-2 | (1-1-3) | 6% |
| 3-HB(F)TB-3 | (1-1-3) | 6% |
| 3-HB(F)TB-4 | (1-1-3) | 4% |
| 3-H2BTB-2 | (1-1-5) | 4% |
| 3-B2BTB-2 | (1-1-6) | 10% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 3-BB(F)B(F,F)-F | (2-2-4) | 3% |
| 2-BTB-O1 | (3-3) | 6.6% |
| 3-BTB-O1 | (3-3) | 6.6% |
| 4-BTB-O1 | (3-3) | 6.6% |
| 4-BTB-O2 | (3-3) | 6.6% |
| 5-BTB-O1 | (3-3) | 6.6% |

NI=92.5° C.; Tc<−10° C.; Δn=0.249; Δ∈=9.7; Vth=1.91 V.

### Example 14

| | | |
|---|---|---|
| 3-HB(F)TB-2 | (1-1-3) | 5% |
| 3-HB(F)TB-3 | (1-1-3) | 5% |
| 3-H2BTB-2 | (1-1-5) | 4% |
| 4-B(F)TB(F)TB-5 | (1-1-12) | 10% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 3-BB(F)B(F,F)-F | (2-2-4) | 3% |
| 2-BTB-O1 | (3-3) | 7.8% |
| 3-BTB-O1 | (3-3) | 7.8% |
| 4-BTB-O1 | (3-3) | 7.8% |
| 4-BTB-O2 | (3-3) | 7.8% |
| 5-BTB-O1 | (3-3) | 7.8% |

NI=88.9° C.; Tc<−20° C.; Δn=0.262; Δ∈=9.4; Vth=1.81 V.

### Example 15

| | | |
|---|---|---|
| 3-HB(F)TB-2 | (1-1-3) | 7% |
| 3-HB(F)TB-3 | (1-1-3) | 6% |
| 3-HB(F)TB-4 | (1-1-3) | 6% |
| 3-H2BTB-2 | (1-1-5) | 4% |
| 3-H2BTB-3 | (1-1-5) | 3% |
| 3-BB(F,F)XB(F,F)-F | (2-1-2) | 11% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F)B(F,F)-F | (2-2-4) | 3% |
| 3-BB(F)B(F,F)-CF3 | (2-2-5) | 5% |
| 2-BTB-O1 | (3-3) | 7.8% |
| 3-BTB-O1 | (3-3) | 7.8% |
| 4-BTB-O1 | (3-3) | 7.8% |
| 4-BTB-O2 | (3-3) | 7.8% |
| 5-BTB-O1 | (3-3) | 7.8% |

NI=88.6° C.; Tc<−10° C.; Δn=0.246; Δn=8.9; Vth=1.88 V.

### Example 16

| | | |
|---|---|---|
| 3-BB(F)TB-2 | (1-1-4) | 8% |
| 3-BB(F)TB-3 | (1-1-4) | 8% |
| 3-BB(F)TB-4 | (1-1-4) | 8% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 3-BB(F)B(F,F)-F | (2-2-4) | 3% |
| 2-BTB-O1 | (3-3) | 7.8% |
| 3-BTB-O1 | (3-3) | 7.8% |
| 4-BTB-O1 | (3-3) | 7.8% |
| 4-BTB-O2 | (3-3) | 7.8% |
| 5-BTB-O1 | (3-3) | 7.8% |

NI=91.3° C.; Tc<−10° C.; Δn=0.278; Δ∈=9.9; Vth=1.87 V.

### Example 17

| | | |
|---|---|---|
| 3-BB(F)TB-2 | (1-1-4) | 6% |
| 3-BB(F)TB-3 | (1-1-4) | 6% |
| 3-BB(F)TB-4 | (1-1-4) | 6% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 9% |
| 5-BB(F)B(F,F)XB(F,F)-F | (2-1-6) | 9% |
| 3-BB(F,F)XB(F)B(F,F)-F | (2-1-10) | 12% |
| 5-BB(F)B(F,F)XB(F)B(F,F)-F | (2-1-11) | 10% |
| 4-BB(F)B(F,F)XB(F,F)-CF3 | (2-1-13) | 5% |
| 3-BB(F)B(F,F)-F | (2-2-4) | 5% |
| 3-BB(F)B(F,F)-CF3 | (2-2-5) | 7% |
| 2-BTB-O1 | (3-3) | 2.2% |
| 3-BTB-O1 | (3-3) | 2.2% |
| 4-BTB-O1 | (3-3) | 2.2% |
| 4-BTB-O2 | (3-3) | 2.2% |
| 5-BTB-O1 | (3-3) | 2.2% |

NI=99.3° C.; Tc<−10° C.; Δn=0.264; Δ∈=28.5; Vth=1.51 V.

### Example 18

| | | |
|---|---|---|
| 3-BB(F)TB-2 | (1-1-4) | 8% |
| 3-BB(F)TB-3 | (1-1-4) | 8% |
| 3-BB(F)TB-4 | (1-1-4) | 8% |
| 3-BBXB(F,F)-F | (2-1-1) | 4% |
| 3-BB(F,F)XB(F,F)-F | (2-1-2) | 9% |
| 3-GB(F,F)XB(F,F)-F | (2-1-4) | 4% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-GB(F)B(F,F)XB(F,F)-F | (2-1-9) | 3% |
| 4-GB(F)B(F,F)XB(F,F)-F | (2-1-9) | 3% |
| 5-GB(F)B(F,F)XB(F,F)-F | (2-1-9) | 3% |
| 3-BB(F,F)XB(F)B(F,F)-F | (2-1-10) | 6% |
| 3-BB(F)B(F,F)-F | (2-2-4) | 3% |
| 3-GB(F)B(F,F)-F | (2-2-8) | 3% |
| 3-GBB(F)B(F,F)-F | (2-2-9) | 3% |
| 4-GBB(F)B(F,F)-F | (2-2-9) | 3% |
| 2-BTB-O1 | (3-3) | 2.6% |
| 3-BTB-O1 | (3-3) | 2.6% |
| 4-BTB-O1 | (3-3) | 2.6% |
| 4-BTB-O2 | (3-3) | 2.6% |
| 5-BTB-O1 | (3-3) | 2.6% |

NI=97.2° C.; Tc<−20° C.; Δn=0.249; Δ∈=19.0; Vth=1.76 V.

### Example 19

| | | |
|---|---|---|
| 3-BB(F)TB-2 | (1-1-4) | 8% |
| 3-BB(F)TB-3 | (1-1-4) | 8% |
| 3-BB(F)TB-4 | (1-1-4) | 8% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 3-BB(F)B(F,F)-F | (2-2-4) | 3% |
| 2-BTB-O1 | (3-3) | 3% |
| 3-BTB-O1 | (3-3) | 3% |
| 4-BTB-O1 | (3-3) | 3% |
| 4-BTB-O2 | (3-3) | 3% |
| 5-BTB-O1 | (3-3) | 3% |
| 1-BB(F)B-2V | (3-8) | 3% |
| 2-BB(F)B-2V | (3-8) | 3% |
| 3-BB(F)B-2V | (3-8) | 3% |
| 2-BB(F)B-3 | (3-8) | 3% |
| 2-BB(F)B-5 | (3-8) | 3% |
| 3-BB(F)B-5 | (3-8) | 3% |
| 2-BB(2F,5F)B-2 | (3-9) | 3% |
| 3-BB(2F,5F)B-3 | (3-9) | 3% |

NI=104.5° C.; Tc<−20° C.; Δn=0.279; Δ∈=10.3; Vth=1.93 V.

### Example 20

| | | |
|---|---|---|
| 3-BB(F)TB-2 | (1-1-4) | 8% |
| 3-BB(F)TB-3 | (1-1-4) | 8% |
| 3-BB(F)TB-4 | (1-1-4) | 8% |
| 3-BB(F,F)XB(F,F)-F | (2-1-2) | 9% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 7% |
| 5-BB(F)B(F,F)XB(F,F)-F | (2-1-6) | 7% |
| 3-BB(F,F)XB(F)B(F,F)-F | (2-1-10) | 6% |
| 3-BB(F)B(F,F)-F | (2-2-4) | 3% |
| 3-HB-O2 | (3-1) | 3% |
| 5-HB-O2 | (3-1) | 3% |
| 7-HB-1 | (3-1) | 3% |
| 1-BB-3 | (3-2) | 3% |
| 1-BB-5 | (3-2) | 3% |
| 2-BTB-O1 | (3-3) | 2.4% |
| 3-BTB-O1 | (3-3) | 2.4% |
| 4-BTB-O1 | (3-3) | 2.4% |
| 4-BTB-O2 | (3-3) | 2.4% |
| 5-BTB-O1 | (3-3) | 2.4% |
| 3-HBB-2 | (3-5) | 3% |
| 5-HBB-2 | (3-5) | 3% |
| 5-B(F)BB-2 | (3-7) | 3% |
| 5-B(F)BB-3 | (3-7) | 3% |

NI=93.7° C.; Tc<−20° C.; Δn=0.247; Δ∈=9.9; Vth=1.88 V.

### Example 21

| | | |
|---|---|---|
| 3-HB(F)TB-2 | (1-1-3) | 5% |
| 3-HB(F)TB-3 | (1-1-3) | 3% |
| 3-BB(F)TB-2 | (1-1-4) | 8% |
| 3-BB(F)TB-3 | (1-1-4) | 8% |
| 3-BB(F)TB-4 | (1-1-4) | 8% |
| 3-BB(F,F)XB(F,F)-F | (2-1-2) | 10% |
| 3-BB(F)B(F,F)XB(F)-F | (2-1-5) | 3% |
| 3-BB(F)B(F,F)XB(F,F)-F | (2-1-6) | 2% |
| 4-BB(F)B(F,F)XB(F,F)-F | (2-1-6) | 8% |
| 5-BB(F)B(F,F)XB(F,F)-F | (2-1-6) | 8% |
| 3-BB(F,F)XB(F)B(F,F)-F | (2-1-10) | 6% |
| 2-BTB-O1 | (3-3) | 6.2% |
| 3-BTB-O1 | (3-3) | 6.2% |
| 4-BTB-O1 | (3-3) | 6.2% |
| 4-BTB-O2 | (3-3) | 6.2% |
| 5-BTB-O1 | (3-3) | 6.2% |

NI=103.5° C.; Tc<−10° C.; Δn=0.278; Δ∈=10.6; Vth=1.94 V; η=57.2 mPa·s; γ1=316 mPa·s.

### INDUSTRIAL APPLICABILITY

A liquid crystal composition of the invention satisfies at least one of characteristics such as a high maximum temperature, a low minimum temperature, a large optical anisotropy, a large positive dielectric anisotropy and a high stability to ultraviolet light, or has a suitable balance regarding at least two of the characteristics. A liquid crystal display device including the composition can be used in an active matrix (AM) device having a TN mode, an OCB mode, an IPS mode, an FFS mode or an FPA mode, particularly, a production cost can be decreased by encapsulating the composition, or the resulting product can also be used in a flexible display. Moreover, the device including the composition can be used as a display device that allows switching of display between 2D and 3D.

1. A liquid crystal composition that contains at least one compound selected from the group of compounds represented by formula (1) as a first component and at least one compound selected from the group of compounds represented by formula (2) as a second component, wherein a proportion of a compound having cyano is less than 3% by weight based on a total of the liquid crystal composition: 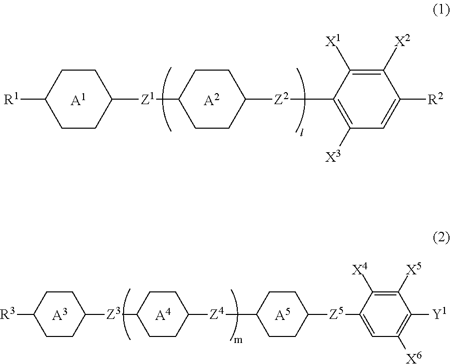
wherein, in formula (1) and formula (2), R¹, R² and R³ are independently alkyl having 1 to 12 carbons, alkoxy having 1 to 12 carbons or alkenyl having 2 to 12 carbons; rings A¹, A², A³, A⁴ and A⁵ are independently 1,4-cyclohexylene, 1,4-phenylene, 2-fluoro-1,4-phenylene, 2,5-difluoro-1,4-phenylene, 2,6-difluoro-1,4-phenylene, pyridine-2,5-diyl, pyrimidine-2,5-diyl, 1,3-dioxane-2,5-diyl or tetrahydropyran-2,5-diyl; Z¹, Z², Z³, Z⁴ and Z⁵ are independently a single bond, ethylene, vinylene, methyleneoxy, carbonyloxy, difluoromethyleneoxy, tolan or tetrafluoroethylene, in which at least one of Z¹ and Z² is tolan; X¹, X², X³, X⁴, X⁵ and X⁶ are independently hydrogen or fluorine, in which X¹ and X² are not fluorine simultaneously, and X⁴ and X⁵ are not fluorine simultaneously; Y¹ is fluorine, chlorine, alkyl having 1 to 12 carbons in which at least one piece of hydrogen is replaced by halogen, alkoxy having 1 to 12 carbons in which at least one piece of hydrogen is replaced by halogen, or alkenyl having 2 to 12 carbons in which at least one piece of hydrogen is replaced by halogen; and l is 1 or 2, m is 0, 1 or 2, and when l and m represent 2, a plurality of ring A², ring A⁴, Z² and Z⁴ may be identical or different, respectively.

2. The liquid crystal composition according to claim 1, wherein a proportion of the first component is in the range of 20% by weight to 70% by weight, and a proportion of the second component is in the range of 25% by weight to 75% by weight, based on a weight of the liquid crystal composition.

3. The liquid crystal composition according to claim 1, containing at least one compound selected from the group of compounds represented by formula (1-1) as the first component and at least one compound selected from the group of compounds represented by formula (2-1) as the second component: 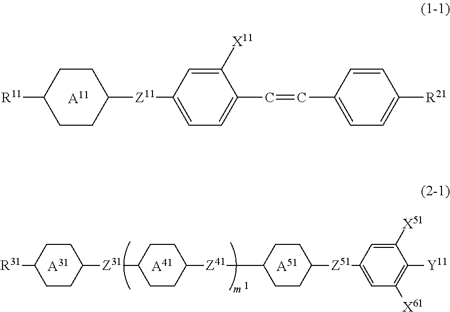
wherein, in formula (1-1) and formula (2-1), R¹¹, R²¹ and R³¹ are independently alkyl having 1 to 12 carbons, alkoxy having 1 to 12 carbons or alkenyl having 2 to 12 carbons; ring A¹¹ is 1,4-cyclohexylene, 1,4-phenylene, 2-fluoro-1,4-phenylene, 2,5-difluoro-1,4-phenylene or 2,6-difluoro-1,4-phenylene; ring A³¹ is 1,4-phenylene, 2-fluoro-1,4-phenylene, 2,6-difluoro-1,4-phenylene, pyridine-2,5-diyl, pyrimidine-2,5-diyl, 1,3-dioxane-2,5-diyl or tetrahydropyran-2,5-diyl; ring A⁴¹ and ring A⁵¹ are independently 1,4-phenylene, 2-fluoro-1,4-phenylene or 2,6-difluoro-1,4-phenylene; Z¹¹, Z³¹, Z⁴¹ and Z⁵¹ are independently a single bond, ethylene, vinylene, methyleneoxy, carbonyloxy, difluoromethyleneoxy, tolan or tetrafluoroethylene, in which at least one of Z³¹, Z⁴¹ and Z⁵¹ is difluoromethyleneoxy; X¹¹, X⁵¹ and X⁶¹ are independently hydrogen or fluorine; Y¹¹ is fluorine, chlorine, alkyl having 1 to 12 carbons in which at least one piece of hydrogen is replaced by halogen, alkoxy having 1 to 12 carbons in which at least one piece of hydrogen is replaced by halogen, or alkenyl having 2 to 12 carbons in which at least one piece of hydrogen is replaced by halogen; and m¹ is 0, 1 or 2, and when m¹ represents 2, a plurality of ring A⁴¹ and Z⁴¹ may be identical or different, respectively.

4. The liquid crystal composition according to claim 1, containing at least one compound selected from the group of compounds represented by formula (1-1-1) to formula (1-1-13) as the first component: 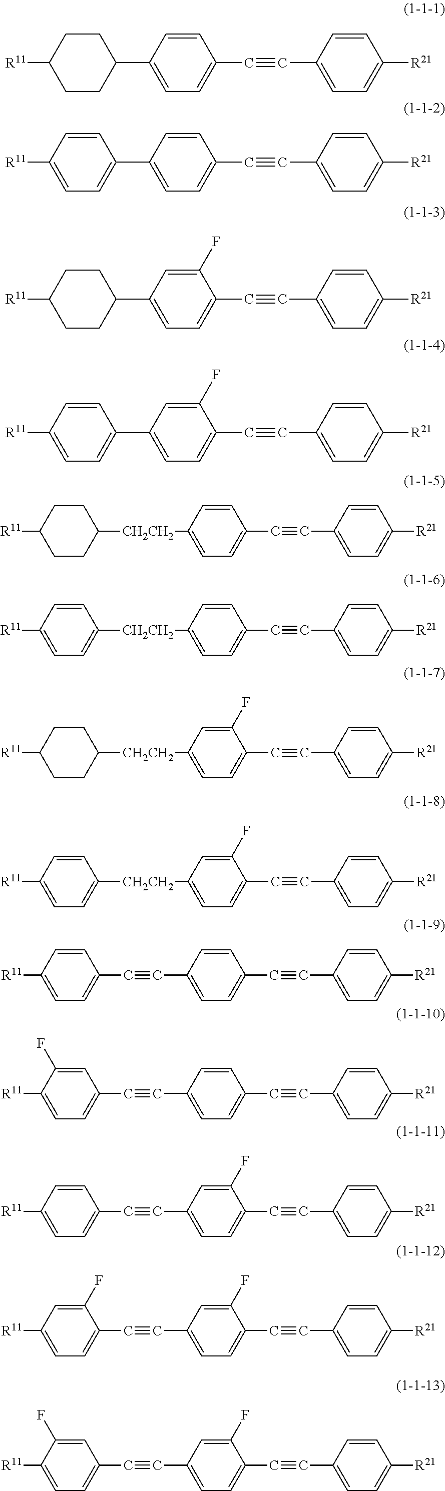
wherein, in the formulas, R¹¹ and R²¹ are independently alkyl having 1 to 12 carbons, alkoxy having 1 to 12 carbons or alkenyl having 2 to 12 carbons.

5. The liquid crystal composition according to claim 3, wherein a proportion of the at least one compound represented by formula (1-1) is in the range of 10% by weight to 50% by weight based on a weight of the liquid crystal composition.

6. The liquid crystal composition according to claim 1, containing at least one compound selected from the group of compounds represented by formula (2-1-1) to formula (2-1-13) as the second component: 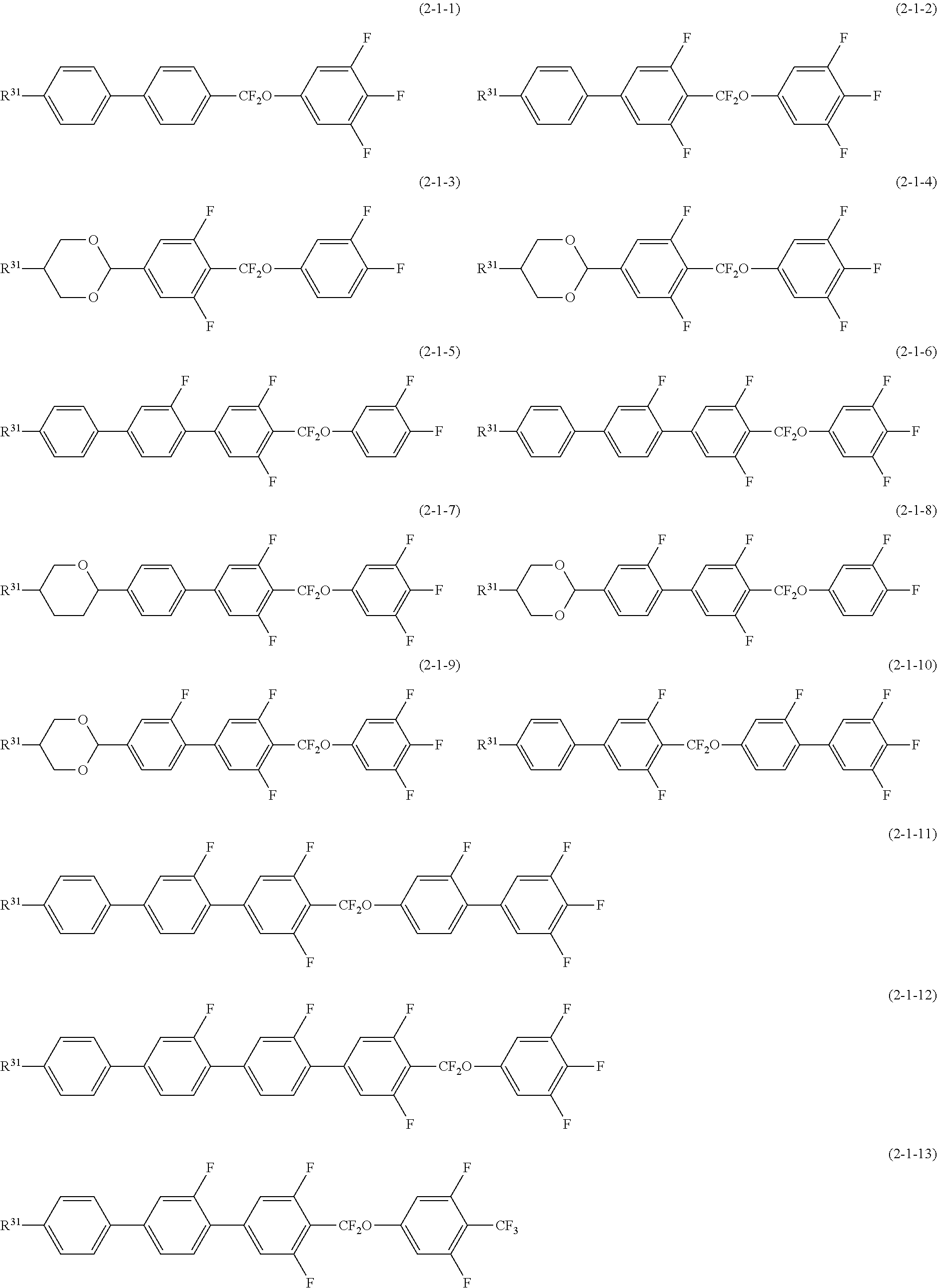
wherein, in the formulas, R³¹ is alkyl having 1 to 12 carbons, alkoxy having 1 to 12 carbons or alkenyl having 2 to 12 carbons.

7. The liquid crystal composition according to claim 3, wherein a proportion of the at least one compound represented by formula (2-1) is in the range of 25% by weight to 70% by weight based on a weight of the liquid crystal composition.

8. The liquid crystal composition according to claim 1, containing at least one compound selected from the group of compounds represented by formula (2-2) as the second component: 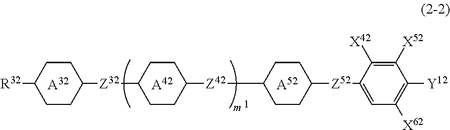
wherein, in formula (2-2), R³² is alkyl having 1 to 12 carbons, alkoxy having 1 to 12 carbons or alkenyl having 2 to 12 carbons; ring A³² is 1,4-phenylene, 2-fluoro-1,4-phenylene, 2,6-difluoro-1,4-phenylene, pyridine-2,5-diyl, pyrimidine-2,5-diyl, 1,3-dioxane-2,5-diyl or tetrahydropyran-2,5-diyl; ring A⁴² and ring A⁵² are independently 1,4-phenylene, 2-fluoro-1,4-phenylene or 2,6-difluoro-1,4-phenylene; Z³², Z⁴² and Z⁵² are independently a single bond, ethylene, vinylene, methyleneoxy, carbonyloxy, tolan or tetrafluoroethylene; X⁴², X⁵² and X⁶² are independently hydrogen or fluorine, in which X⁴² and X⁵² are not fluorine simultaneously; Y¹² is fluorine, chlorine, alkyl having 1 to 12 carbons in which at least one piece of hydrogen is replaced by halogen, alkoxy having 1 to 12 carbons in which at least one piece of hydrogen is replaced by halogen, or alkenyl having 2 to 12 carbons in which at least one piece of hydrogen is replaced by halogen; and m² is 0, 1 or 2, and when m² represents 2, a plurality of ring A⁴² and Z⁴² may be identical or different, respectively.

9. The liquid crystal composition according to claim 1, containing at least one compound selected from the group of compounds represented by formula (2-2-1) to formula (2-2-12) as the second component: 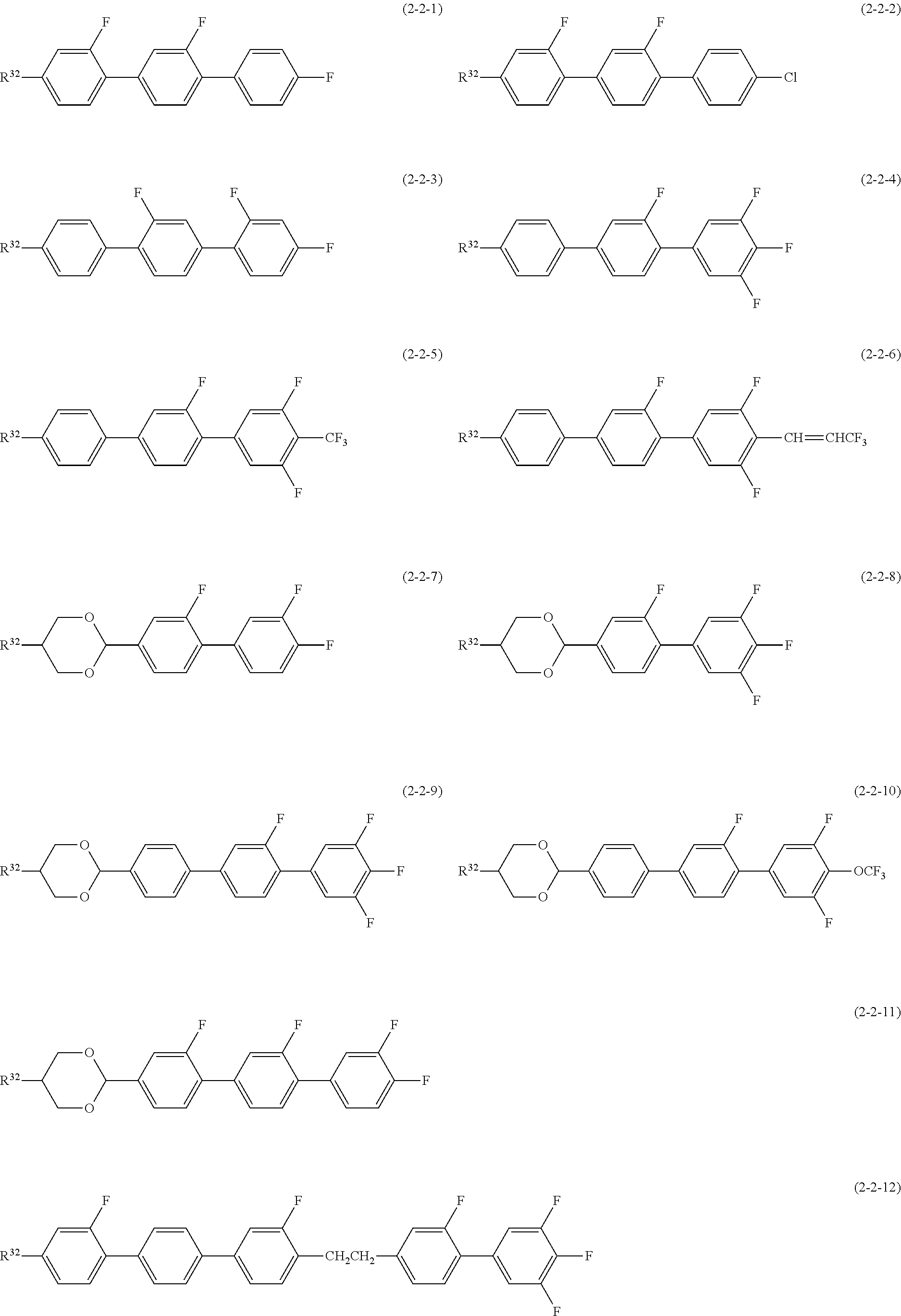
wherein, in the formulas, R³² is alkyl having 1 to 12 carbons, alkoxy having 1 to 12 carbons or alkenyl having 2 to 12 carbons.

10. The liquid crystal composition according to claim 8, wherein a proportion of the at least one compound represented by formula (2-2) is in the range of from greater than 0% by weight to 50% by weight based on a weight of the liquid crystal composition.

11. The liquid crystal composition according to claim 1, further containing at least one compound selected from the group of compounds represented by formula (3) as a third component: 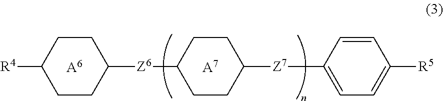
wherein, in formula (3), R⁴ and R⁵ are independently alkyl having 1 to 12 carbons, alkoxy having 1 to 12 carbons or alkenyl having 2 to 12 carbons; ring A⁶ or ring A⁷ is independently 1,4-cyclohexylene, 1,4-phenylene, 2-fluoro-1,4-phenylene, 2,5-difluoro-1,4-phenylene or 2,6-difluoro-1,4-phenylene; Z⁶ is a single bond, ethylene, vinylene, methyleneoxy, carbonyloxy, difluoromethyleneoxy, tolan or tetrafluoroethylene; Z⁷ is a single bond, ethylene, vinylene, methyleneoxy, carbonyloxy, difluoromethyleneoxy or tetrafluoroethylene; and n is 0, 1 or 2, and when n is 1 or 2, Z⁶ is not tolan, and when n represents 2, a plurality of ring A⁷ and Z⁷ may be identical or different, respectively.

12. The liquid crystal composition according to claim 11, containing at least one compound selected from the group of compounds represented by formula (3-1) to formula (3-12) as the third component: 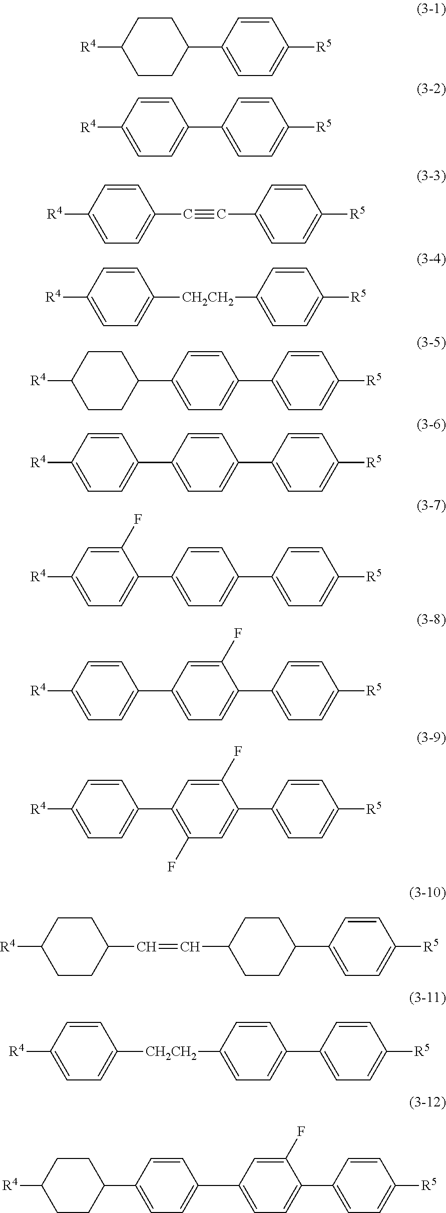
wherein, in the formulas, R⁴ and R⁵ are independently alkyl having 1 to 12 carbons, alkoxy having 1 to 12 carbons or alkenyl having 2 to 12 carbons.

13. The liquid crystal composition according to claim 11, wherein a proportion of the third component is in the range of 10% by weight to 55% by weight based on the weight of the liquid crystal composition.

14. The liquid crystal composition according to claim 1, wherein an optical anisotropy (measured at 25° C.) at a wavelength of 589 nanometers is in the range of 0.20 to 0.35, and a dielectric anisotropy (measured at 25° C.) at a frequency of 1 kHz is in the range of 8 to 40.

15. A liquid crystal display device, including the liquid crystal composition according to claim 1.

16. The liquid crystal display device according to claim 15, wherein the liquid crystal composition is encapsulated.

17. The liquid crystal display device according to claim 15, wherein the liquid crystal composition is used in a display device that allows switching of display between 2D and 3D.

18. Use of the liquid crystal composition according to claim 1 in a liquid crystal display device.
